(19) United States
(12) Patent Application Publication
(10) Pub. No.: US 2004/0078224 A1
(43) Pub. Date: Apr. 22, 2004

(54) Computer assisted and/or implemented process and system for searching and producing source-specific sets of search results and a site search summary box

(75) Inventors: Susan Schramm-Apple, Hatfield, PA (US); Sean Dippold, Schwenksville, PA (US); Melanie Kittrell, Maple Glen, PA (US); Keith Bauer, Souderton, PA (US); Lori Moore, Lafayette Hill, PA (US)

Correspondence Address: HALE & DORR LLP, THE WILLARD OFFICE BUILDING, 1455 PENNSYLVANIA AVE, NW, WASHINGTON, DC, 20004, US

(73) Assignee: Merck & Co., Inc., Rahway, NJ

(21) Appl. No.: 10/390,165

(22) Filed: Mar. 18, 2003

Related U.S. Application Data
(60) Provisional application No. 60/364,743, filed on Mar. 18, 2002.

(51) Int. Cl. G06F 17/60

(52) U.S. Cl. 705/2

(57) ABSTRACT

The invention provides a method, system, and computer program device for an embedded search with site search summary. The search provides an easy-to-navigate user interface that is also intuitive for healthcare professionals, for specifying the search request, and for displaying the search results together with a site search summary. In order to specify the search request, the user enters the keyword or phrase of interest and chooses a category of resources in which to search, where the categories correspond to physician-intuitive groupings of types of resources. A search specific results page including a site search summary box and initially indicating search results within category is returned, both of which thereby provide a number of possibilities for drill down. In this way, the search results may be provided in top levels divided into categories; search results returned may be provided for a particular category; search results returned may be provided from a single resource, listed in order by a predefined preference (e.g., relevance); an item returned in the search results may be reviewed; and/or the sources returning results may be listed, e.g., in the site search summary.

### RELATED APPLICATIONS

This application claims priority to U.S. Provisional Patent Application No. 60/364,743, “Computer Implemented and/or Assisted Process and System for MerckMedicus” filed Mar. 18, 2002, incorporated herein by reference.

This application is related to the following U.S. patent applications: Attorney docket numbers 105456.121, 105456.123, 105456.124, 105456.125, and 105456.127, to the same inventors, and all of which are incorporated herein by reference.

### BACKGROUND OF THE INVENTION

1. Field of the Invention

The present invention is directed to computer related and/or assisted systems, methods, and computer program devices for searching and providing search results for health care professionals. More particularly, it relates to methods and systems for searching and producing source-specific sets of search results, and a search summary, for healthcare professional users, e.g., physicians and other healthcare providers.

2. Description of the Related Art

In the healthcare field, healthcare professionals conventionally may obtain information from medical publishers, with most of this information being just in print. On the other hand, academic institutions have considerable libraries, which unfortunately are not universally available to physicians. Hence, paper resources with healthcare information may be considerable but difficult to access.

In an attempt to provide information electronically, early websites with limited information were sponsored by a variety of commercial entities, academic institutions, or medical associations. There was, nevertheless, a lack of awareness among physicians of the web as a resource for providing information and/or other resources needed by physicians. Premium resources might be provided on some of these sites, nevertheless, there was limited exposure and/or access to these premium resources for physicians and other healthcare professionals.

These conventional means of providing information and other healthcare professional resources resulted in an uneven playing field for healthcare providers. In addition, there are a number of other hurdles facing office-based, rural and non-institutional healthcare professionals.

Physicians and other healthcare providers are presently adapted to the current situation. They are unlikely to change their current habits. Although there is a much greater degree of information available, unfortunately it will not find its way into the hands of physicians and healthcare providers, and ultimately will not result in improved healthcare. Nevertheless, the ability to save time and/or money is one of the primary motivators for physicians or healthcare professionals to change their habits.

Conventionally, the information and/or information gathering process is difficult and awkward for healthcare providers. The information might not be provided in one convenient place. Moreover, the information itself might be inconvenient. For example, if the information is provided by subscription, it is typically expensive to obtain multiple subscriptions. On the other hand information in textbooks might not be up-to-date. Further, textbooks, journals and libraries are not at all suited to physicians' nomadic working style, which typically includes travel between an office and a hospital. Information that might be provided over the web may be jumbled or confused, with multiple places, passwords, formats, browsers and search engines provided for a variety of information. Ultimately, physicians and other providers have entirely too many subscriptions, accounts, ID's and passwords, making the information awkward.

With regard to utilizing the Internet, the physicians might suspect the quality of information or services provided online. Moreover, such information and services might be biased, for example as a result of a sponsor of a particular product, unbeknownst to the users. Where information in sites is searchable, the search engines that are provided might not retrieve search results that are most relevant to the physician's query.

In some situations, the access to information or services might be tied to a specific license or specialized access technology. For example, in order to obtain certain information or services, the physician might be required to use a specific computer or install certain technology.

In addition, sites that are provided by pharmaceutical companies do not tend to focus on physicians. These sites are product driven and patient oriented. They fail to provide for the needs of the physician as a customer. In short, it is difficult to obtain information or services via conventional methods.

One specific example of a website directed to physicians is Medscape/WebMD. Unbeknownst to physicians, however, Medscape/WebMD is commercially sponsored and exhibits a bias. As another example, this site gives physicians limited access to premium resources, such as the best journals and text, because there is no financial incentive to make this information available. Moreover, typical of these types of sites, Medscape/WebMD does not have access to the premium resources sufficient to place them online.

Meanwhile, physicians are facing an increasing number of pressures. These pressures on healthcare practitioners include an increase in time pressures, perhaps caused by busy practices and overwhelming paperwork. At the same time, healthcare practitioners face decreasing practice revenues. They also face information overload, with a decreasing amount of time to sort through the relevant information.

The inventors have determined that physicians or other healthcare professionals engage in a number of online activities, including literature searches, reading medical news in the professional press, reading professional journals, finding patient educational materials, using drug reference databases, researching upcoming meetings, engaging in online continuing medical education (CE), reading medical news in the lay press, communicating with colleagues, finding out about clinical trials, learning about medical devices, reading medical text, and/or participating in MD chat rooms

The inventors have determined that physicians refer to medical information sites primarily to find news and reference materials. In one study by the inventors in responding to a question about the three most important factors a physician uses in determining which medical information sites to use, the following responses were provided:

| Description | Percent |
|---|---|
| Medline Literature Search | 64% |
| Medical News Updates and Alerts | 53% |
| Medical Journals | 47% |
| Drug Reference Database | 34% |
| Medical Textbooks | 30% |
| Continuing Education Online | 29% |
| Courses | |
| Patient Relationship Information | 20% |
| and Guides | |
| Clinical Trial Information and | 15% |
| Links | |
| Listing of Medical Organizations | 7% |
| and Meetings | |
| Financial and World News | 5% |
| Community and Messages Boards | 4% |

The inventors performed extensive research with physicians about website features and functionality, including advisory boards, one-on-ones and online user ability testing. The above table highlights the findings of the online usability test of 154 physician respondents.

According to the Online Physician Market Dynamics Study (ZIMENT), February/March 2001, (Q9), quality, credibility and ease of use are the most important features to physicians in an online service. The following are attributes that are important to specialists and primary care physicians:

Provides credible information

Provides quality information

Is easy to use*

Provides up-to-date health and medical information*

Enables effective research of usual cases or conditions

Is comprehensive

Offers premium medical resources not easily accessible elsewhere

Helps physicians communicate better with patients

Is available to doctors only and not general consumers

Offers ability to customize site based on preferences or specialty

Has a professional look and feel

Is unique from other sites (* These attributes are less important to specialists than primary care physicians.)

Certain aspects of conventional systems for providing healthcare information are illustrated by way of example in FIG. 1, also described in U.S. Pat. No. 6,336,117, Massarani, incorporated herein by reference. Massarani discloses a content-indexing search system and method that provides search results consistent with content filtering and blocking policies. FIG. 1 is a block diagram of Massarani's information retrieval system showing a content server having a database, a caching engine implementing blocking policies, and an external search engine. An information retrieval system 100 includes client devices 102, 104 connected through an internal or controlled network 107 to an external information system 106 such as the Internet or other distributed data network. A typical client is a PC having a display 110, a keyboard 111, a CPU 112, a memory 113 and a network connectivity I/O device 115. A browser 116, such as those sold under the trademark Netscape Communicator, IBM Web Explorer, and the like, is installed in the memory 113 along with a standard operating system 117 and application programs 118. The browser 116 runs or executes in the client device 102, 104 for loading or downloading content from a content server 120 via the Internet 106. Each content server includes a database 122 for storing data responsive to content requests from the clients 102, 104, etc. In one form, data is stored as a collection of HTML documents containing text and other multi-media content. A gateway 124 is used to interface more than one client or internal network segments 107 to the Internet 106 as shown.

A proxy server that includes a cache and content filtering engine 126 is inserted in the connection path from the internal network 107 to the Internet 106, to increase performance and control by implementing a content blocking policy. The caching and blocking proxy server may be, e.g., connected to the gateway or have parallel direct connections to the internal 107 and external 106 networks. A client system 102, 104 running the web browser 116 requests content from the content server 120 using a Hypertext Transfer Protocol (HTTP) request and receiving the content in a HTTP response. A user may generate a content request by explicitly asking for content stored in the content server or by selecting a hyperlink anchor which points to contents stored on content servers. Upon receipt, the browser loads requested content using an HTTP session. A user of a client system utilizing the web browser 116 will often access a conventional search engine server 130, 135 and databases 131, 136, respectively, to locate Internet content by means of keyword searches. These secured search engine servers can be external 130, or internal 135 to the controlled network 107. As a result of a keyword search directed at a search engine server 130 or 135, end users will see displayed in the web browser 116 a list of matching URLs and text excerpts displayed as hyperlink anchors to the ultimate content. The user can then select and follow the link to one or more content matches using the web browser 116.

Other aspects of conventional systems are illustrated by way of example in FIG. 2, also described in U.S. Pat. No. 6,505,196, Drucker et al., incorporated herein by reference. Drucker discloses a typical search interface. When a search is performed the user receives a display of the results with a list 210 of articles matching the search criteria specified by the user. At the top of the results screen in this example is a number of action buttons 200-203. Action button 200 obtains a long record for all the documents recovered during the search; action button 201 allows the user to download a document to disk; and action button 202 allows the user to order documents; and action button 203 returns the user to an initial search screen. A list 210 contains citations that matched the search query entered by the user. A short record 211-214 represents a shortened version of each citation; this example shows four short records 211-214 of the five hundred and four retrieved. A full citation button 216, and a related articles button 217 are provided. When the related articles button 217 is depressed a new display of citations conceptually related to the first one will appear. The user can go several levels deep and by clicking the related articles button 217 multiple times and can obtain numerous lists of articles that are conceptually related to one another. When the full citation button 216 is depressed, the long record for the adjacent citation is displayed, and sometimes contains an abstract that briefly summarizes the contents of each article.

Still more aspects of traditional search systems are illustrated by way of example in U.S. Pat. No. 6,338,059, Fields et al., incorporated herein by reference, shown in FIG. 3. Fields discloses retrieval and presentation of data from a distributed database such as the Internet. As illustrated in FIG. 3, a search word 361 is selected from a web page 363 at a hosting web server. The hosting web server, acting as a proxy server to the requesting client browser, makes the search request to a content provider web server, e.g., an Internet commercial site. The hosting server recasts the information to a native format so that it appears as though the search results originated at the hosting site. The hosting server extracts the relevant set of content elements from the web page from the web content provider site and plugs the elements into a template having the format, font and navigational elements of the hosting site to create the recast page 365. Fields' system may be implemented as proxy server with modifications to the client browser.

FIGS. 4 and 5 provide examples of search results returned from conventional search engines. FIG. 4, resulting from an Inktomi™ search for articles containing the term “health”, shows 4,774 located references 401, of which the search engine has sorted the top 500 according to its determination of relevance. FIG. 5, illustrating a Google™ search, also for the term “health”, located about 69,700,000 references 401. Both search engines provide the search results seriatim. A user may link to the located reference, and may use the search engine to locate similar pages. The Inktomi search engine also provides a numerical ranking of relevance 403, e.g., 39% in the illustrated example.

The above prior art references, however, fail to meet the needs of today's medical community. For example, we have determined that physicians and healthcare professionals would prefer a search provided via a website with cutting edge tools and resources, available in a single portal, as a key to the medical Internet. We have determined that physicians and other healthcare providers would prefer that such a site is ethical, credible, insightful, unbranded and objective. We have further determined that such a site should be for physicians and healthcare professionals, and provide access to premium medical resources.

None of the conventional systems specifically provide various levels of search summaries and/or search sources and categories to assist in preparation and/or review of search results, particularly where the levels are intuitive to physicians, e.g., items in search results and/or requests grouped by source and/or resource category. Furthermore, conventional systems do not accommodate premium medical resources, such as those that are restricted. It currently is not possible to include premium medical resources in search results in a transparent manner. There remains a need for such assistance for physicians and other healthcare practitioners.

### BRIEF SUMMARY OF THE INVENTION

The present invention alleviates the deficiencies of conventional techniques and systems described above. The invention enables information provision to physicians and other healthcare providers that is more targeted, more efficient and may be permission-based. The invention provides assistance to help physicians to obtain timely and appropriate information to help them practice better medicine. The system, according to one or more aspects of the invention, provides the right information in an intuitive and appropriate format. It also provides for appropriate filtering of information. The present invention fosters the best practice of medicine, which creates simultaneous benefits for physicians, and patients.

The invention provides a level of search summaries appropriate and intuitive to physicians, to assist in preparation and/or review of search results, e.g., searches and search results grouped by resource category. Furthermore, according to one or more embodiments of the present invention, premium medical sources in search results in a transparent manner, even if the premium medical source requires a fee, registration, login, and/or licensure verification.

The present invention makes possible a useful search of a vast collection of resources available to physicians. The invention provides search summaries of a content library unmatched in its breadth. It provides a search engine appropriate for perusing a wide array of medical content, e.g., Harrison's Online, Cecil's Textbook of Medicine, Praxis.md, the Merck Manual and many others. The invention may include a search of sources provided on the system coordinating the search, e.g., a comprehensive professional development content collection; a patient resource content collection, with, e.g., a collection of what patients are seeing in the media, color illustrations, descriptions for medical procedures, and content resources to help locate clinical trials for patients; content collection of clinical workflow tools, e.g., clinical calculators, an ICD-9 search engine, drug interaction checking, and expert systems that assist with antibiotic choices (TheraDoc™) and difficult differential diagnoses (Dxplain™); a content collection of electronic assistants, with e.g., quick links to relevant news and journals, career information and clinical decision support tools that may optionally be downloaded to a physician's handheld computer. A number of unique and powerful features may be provided, such as transparent access to subscription sites (e.g., Harrison's Online, Praxis.md, MD Consult).

The invention provides a method, system, and computer program device for searching medical resources and providing source specific sets of search results and a site search summary to a user, e.g., a physician and/or a healthcare provider. One or more embodiments of the present invention include generating, responsive to a search request received from the user, one or more search queries. The search query includes one or more search terms and a scope of sources to be searched. The sources correspond to one of the categories; and electronic resources correspond to each of the sources; Optionally, the categories include, e.g., at least one of medical news, medical library, and medical profession, or similar.

Also included is performing, responsive to the one or more search queries, a search for the one search term(s) in the electronic resources corresponding to the scope of sources. Further, the invention includes returning one or more sets of search results, with a first indication of resources responsive to the search queries. Moreover, the invention includes displaying, responsive to the set(s) of search results returned, the set(s) of search results to the user, including a first display of the set(s) of search results by category; and a second display of a site search summary, including data representative of each source for the sources searched, and data representing the category corresponding to each source of the sources searched.

The invention further includes displaying, responsive to a first selection of the category in the first display and/or the second display, the one or more sets of search results corresponding to the category. Also included is displaying, responsive to a second selection of at least one of the sources searched, in the first display and/or the second display, the one or more sets of search results in the sources. Also included is displaying, responsive to a third selection of one of the electronic resources in one or more sets of search results, content corresponding to the electronic resource(s).

Optionally, the invention includes checking registration data for the user to ensure that the user is permitted access to a source that is restricted and that corresponds to one of the responsive electronic resources, and if the user is not permitted access, excluding the source from at least one of the displays.

Optionally, the invention includes using one or more search indexes for the search engine. The search engine is instructed to update the one or more search indexes directed to the set of sources by categories.

Further, the invention optionally provides that at least one set of search results has, for each of its returned electronic resources, a second indication of at least one of: category, source, location, title and summary.

Further, optionally according to the invention, data representing the category in said second display includes an icon representing the category. The first selection is of at least one of the category and the icon representing the category.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING(S)

The above-mentioned and other advantages and features of the present invention will be better understood from the following detailed description of the invention with reference to the accompanying drawings, in which:

FIG. 1 is a block diagram of a prior art information retrieval system including a content server and a search engine.

FIG. 2 is an example of a first prior art user interface for search results.

FIG. 3 is a block diagram of a prior art user search engine searching for a search word and providing search results.

FIG. 4 is another example of a second prior art user interface showing search results.

FIG. 5 is still another example of a third prior art user interface showing search results.

FIG. 6 is an exemplary user interface illustrating an example of search results and an example site search summary, according to one or more embodiments of the present invention.

FIG. 7 is an exemplary user interface illustrating in more detail another example of search results and an example site search summary, according to one or more embodiments of the present invention.

FIG. 8 is an exemplary user interface illustrating two advanced searches for conducting a search, according to one or more embodiments of the present invention.

FIG. 9 is an exemplary user interface illustrating an example of search results after utilizing the site search summary to access a further level of detail in a category.

FIG. 10 is another exemplary user interface illustrating an example of search results after utilizing the site search summary to access a further level of detail in another category.

FIG. 11 is an exemplary user interface illustrating a search result to which the user interface according to one or more embodiments of the present invention.

FIG. 12 is a functional block diagram illustrating a search data flow according to one or more embodiments of the present invention.

FIG. 13 is a flow chart illustrating an example of searching and displaying search results, according to one or more embodiments of the present invention.

FIG. 14 is a flow chart illustrating an example of searching according to a glossary, custom or basic search, and grouping search results, according to one or more embodiments of the present invention.

FIG. 15 is a functional block diagram illustrating data flow between a web server, visitor, and a search engine.

FIG. 16 is a block diagram of a computer used for implementing one or more embodiments of the medical information portal system, in accordance with a computer implemented embodiment of the present invention.

FIG. 17 illustrates a block diagram of the internal hardware of the computer of FIG. 16.

FIG. 18 illustrates a block diagram of an alternative computer of a type suitable for carrying out the present invention.

FIG. 19 is a functional block diagram illustrating an example of a computer system for use in connection with searching and producing resource specific sets of search results and a site search summary, suitable for carrying out the invention.

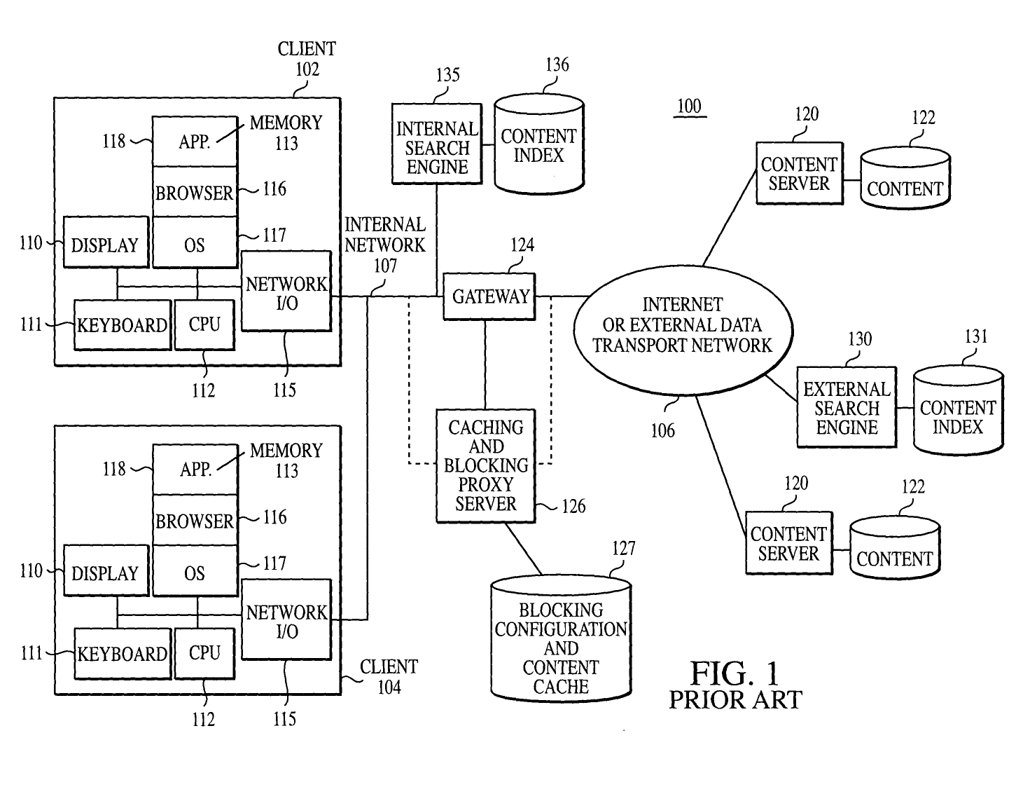

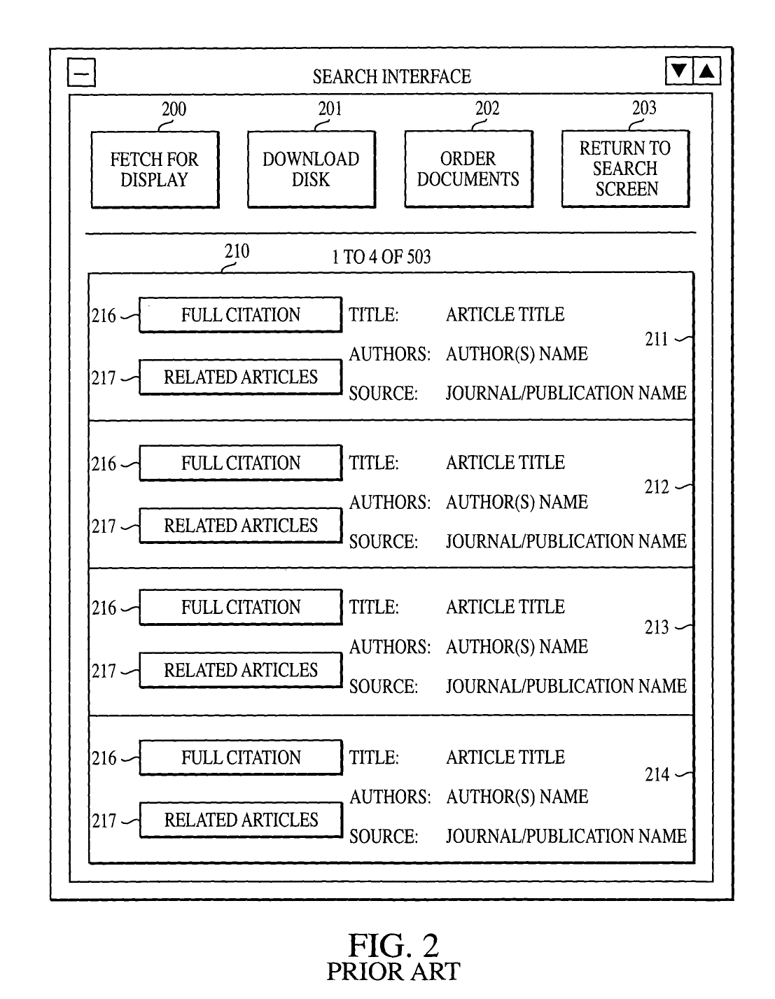

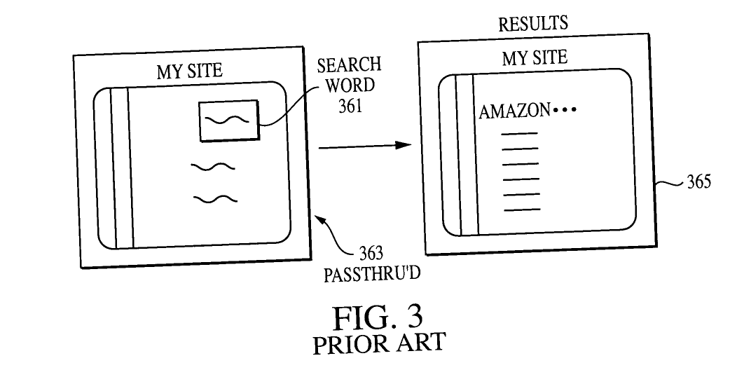

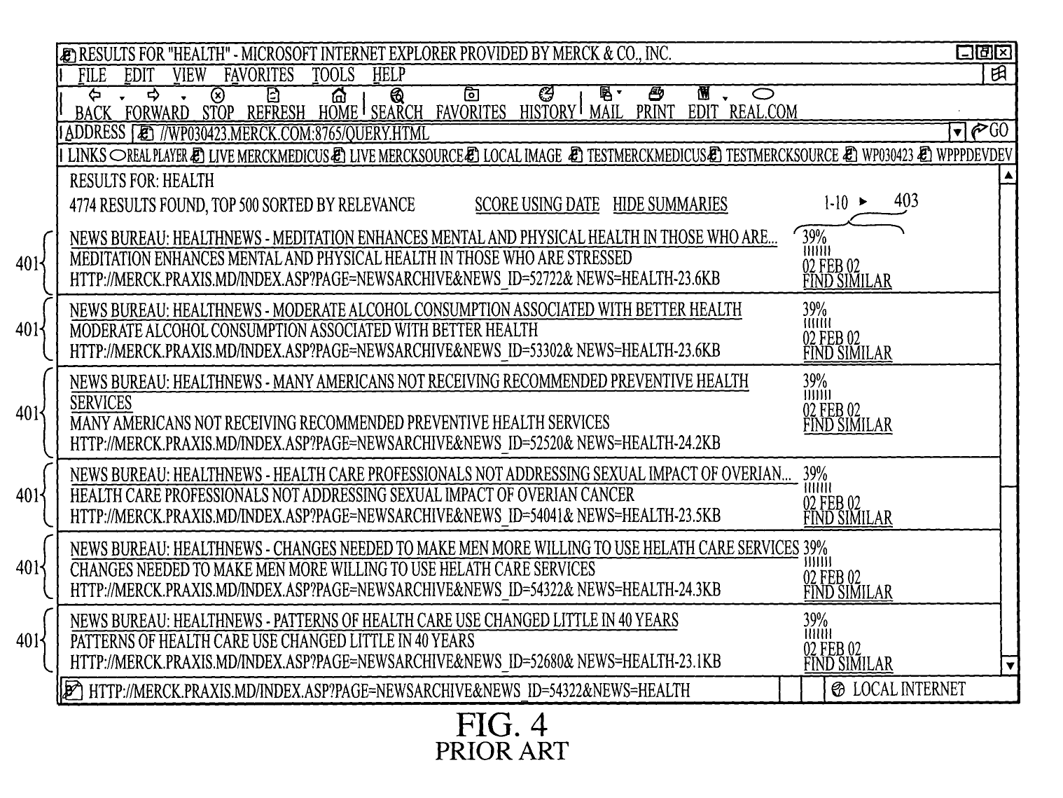

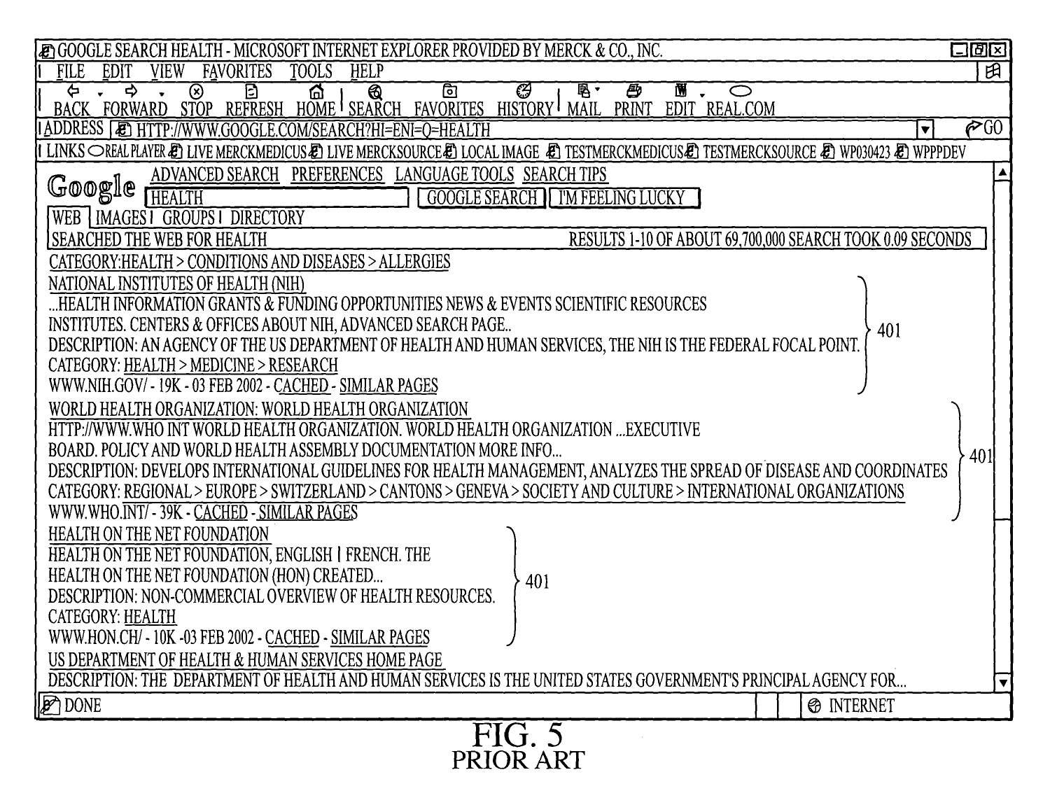

### DETAILED DESCRIPTION OF THE INVENTION

The following detailed description includes many specific details. The inclusion of such details is for the purpose of illustration only and should not be understood to limit the invention. Throughout this discussion, similar elements are referred to by similar numbers in the various figures for ease of reference. In addition, features in one embodiment may be combined with features in other embodiments of the invention.

According to one or more embodiments of the present invention, a system is provided including an embedded search. The search provides an easy-to-navigate user interface that is also intuitive for healthcare professionals, for specifying the search request, and for displaying the search results together with a site search summary. In order to specify the search request, the user enters the keyword or phrase of interest and chooses one or more categories of resources in which to search, where the categories correspond to physician-intuitive groupings of types of sources. Optionally, the sources have previously been indexed by a search engine. A search specific results page including a site search summary and a list of search results within category is returned, both of which thereby provide a number of possibilities for drill down. In this way, the search results may be provided in top levels divided into resource categories; search results returned may be provided for a particular resource category; search results returned may be provided from a single source, listed in order by a predefined preference (e.g., relevance); an item returned in the search results may be reviewed; and/or the sources searched may be listed, e.g., in a site search summary box.

The present invention provides a system and method for bringing together the vast array of resources available to physicians. Hence, according to one or more embodiments, the invention provides access to a content library unmatched in its breadth. It provides a search engine appropriate for perusing content, such as, Harrison's Online, Cecil's Textbook of Medicine, Praxis.md, the Merck Manual and many others. In addition, it provides one or more links to searches such as MD Consult that offer their own extremely comprehensive library. All told, these many resources made accessible via one or more embodiments of the invention covers primary care and/or any specialty. An optional folder feature allows physicians to, for example, document their visits with extensive bookmarking to track their progress (e.g., previously conducted searches, research links). The invention optionally includes a comprehensive professional development area, e.g., with board review questions; an optional medical meeting calendar with access to content from many meetings; and optionally the ability to earn/access CME credit through a partner site. The optional patient resource area exceeds that of most physician web portals, and optionally includes access to an immense collection of patient handouts that physicians may easily print. Other searchable resources include coverage of what patients are seeing in the media, color illustrations and easy-to-read descriptions for numerous medical procedures, and resources to help locate clinical trials for patients. Searchable linical workflow tools optionally include clinical calculators, an ICD-9 search engine, drug interaction checking, and one or more expert systems that assist with antibiotic choices (TheraDoc™) and difficult differential diagnoses (Dxplain™). Optionally, a searchable electronic assistant provides quick links to relevant news and journals, career information and clinical decision support tools that are optionally downloaded to a physician's handheld computer or PDA. A number of unique and powerful features are provided, such as free access to subscription sites (e.g., Harrison's Online, Praxis.md, MD Consult). Another searchable source is a lectures and presentations builder, allowing users to prepare custom slides for incorporation into, e.g., PowerPoint documents, and including, e.g., public speaking advice.

One or more aspects of the invention provide access to healthcare and medical resources. The term “resources” used herein is intended to encompass, e.g., information, services, content, applications, and anything else available electronically. According to one or more embodiments of the present invention, medical information resources include, for example, one or more of reference books and/or databases; several outstanding and/or definitive medical information resources may be accessed electronically, including:

National Library of Medicine databases: MEDLINE, AIDSLINE, Bioethics Line, CANCERLIT,

Harrison's Principles of Medicine,

Dorland's Medical Dictionary,

Physicians' Desk Reference (PDR) and PDR Drug Interaction Database,

Mosby's GenRx, Patient GenRx and Drug Master Plus (drug interaction database),

Merck Manual Online,

Merck Manual Home Edition,

Cecil Textbook of Medicine, and/or

Best Practice of Medicine by PraxisMD

One or more embodiments of the present invention provides users with the ability to search some of these resources individually or use a search engine to retrieve relevant content from the collection of resources. Simple and/or advanced search capabilities are provided.

Another medical information resource is MD Consult, a collection of medical information resources serving the clinical content needs of physicians and other healthcare providers. This is an example of a resource normally available to physicians by subscription only, but are provided to registered users of the present invention.

According to one or more embodiments of the present invention, resources include news, such as available from headlines, abstracts, full journal articles from medical journals, e.g., JAMA, NEJM, Lancet, Annals of Internal Medicine, and BMJ. Other news resources may be provided from a newswire service of breaking news stories about medicine, e.g., those that could impact a physician's practice. Resources also include medical, specialty and/or consumer news. Such articles cover the business of healthcare, consumer medical news, and other health-related news items, and may be obtained from professional and/or lay press resources, e.g., Reuters, FaxWatch, and NewsRX. Optionally, the news directed to the user may be restricted to items of interest to the user, such as matching user registration information.

Another example of medical information resources includes professional development resources and tools, e.g., continuing medical education (CME) information, online CME, a medical meeting calendar with a list of at least major professional conferences, information and/or review modules regarding board review for various therapeutic areas for Board certification and re-certification, links to professional societies, links to government web sites, links to medical schools, and/or access to clinical trials information.

Another type of resource relates to patients, e.g., patient education materials such as leaflets, optionally editable/customizable; patient sheets, e.g., printable articles intended for patients to help them better understand their disease and treatment; patient health news, e.g., an archive of health-related news articles in the popular lay press (off line, online, and/or in print); clinical trial information, e.g., a searchable database of clinical trials such as sponsored by NIH and/or industry; links to support groups serving patients, such as in various disease states; and/or a best health guide, having patient education materials and consumer medical news, that may be customizable, printable, and/or e-mailable.

Yet another type of resource relates to practice technology, including for example, health technology news, including news articles and features about technology issues affecting the practice of medicine; evaluations of health technology vendors, e.g., review/comparison of the latest office technology for physician practices, such as billing and scheduling systems and electronic medical records management; interactive technology services, e.g., e-mail questions and answers, as well as FAQs, from a healthcare technology professor; a technology glossary, e.g., a searchable list of technology terms; and/or a practice technology assessment services, to assess a level of technological sophistication in a doctor's practice.

A further type of resource relates to diagnostic assistance, including for example, disease explanations, to help doctors correctly diagnose, based on physician input of clinical information, and providing possible diagnoses, justifications, suggestions for additional clinical information to obtain, and/or list specific signs/symptoms for a specific disease; practice guidelines providing evidence-based clinical practice guidelines; and/or disease modules, providing overviews of many diseases, e.g., major and/or common disease, including e.g., epidemiology, pathophysiology, diagnosis, and treatment.

Other types of resources include hospital offerings that address the needs of hospital-based audiences (residents, house staff, hospital physicians). Such resources include, e.g., medical calculators/information, including medical and non-medical information, calculators and content from various sources that are targeted to the needs of residents and medical students; an organizer for medical contents and tables on a PDA to assist users while they work with quick, problem-based solutions to medical questions/clinical issues. Resources intended for hospital physicians include, e.g., reference texts, e.g., culled from core site content as most appropriate for hospital physicians, PDA-downloadable content culled from the core site and customizable by the user; a programmable medical calculator for important clinical calculations.

Other resources include, for example, clinical support tools that provide evidence based therapies and treatments, dosage recommendations, based on patient-specific data; an online ICD-9 Code reference for patient education; PDA software; a web-enabled version of well-respected texts, e.g., Brunwald's Atlas of Internal Medicine, including disease images, charts, and tables, which are optionally downloadable for incorporation into, e.g., medical lectures; and a meeting reporter having news, analysis, posters, and lecture summaries from major medical meetings.

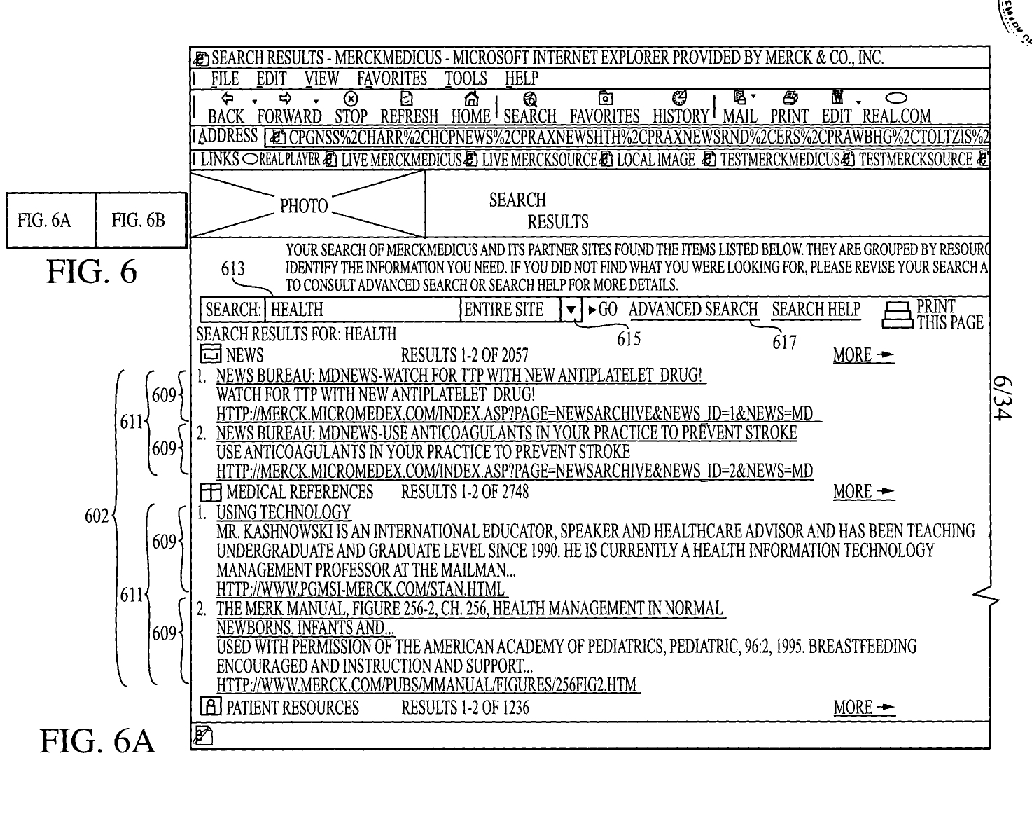

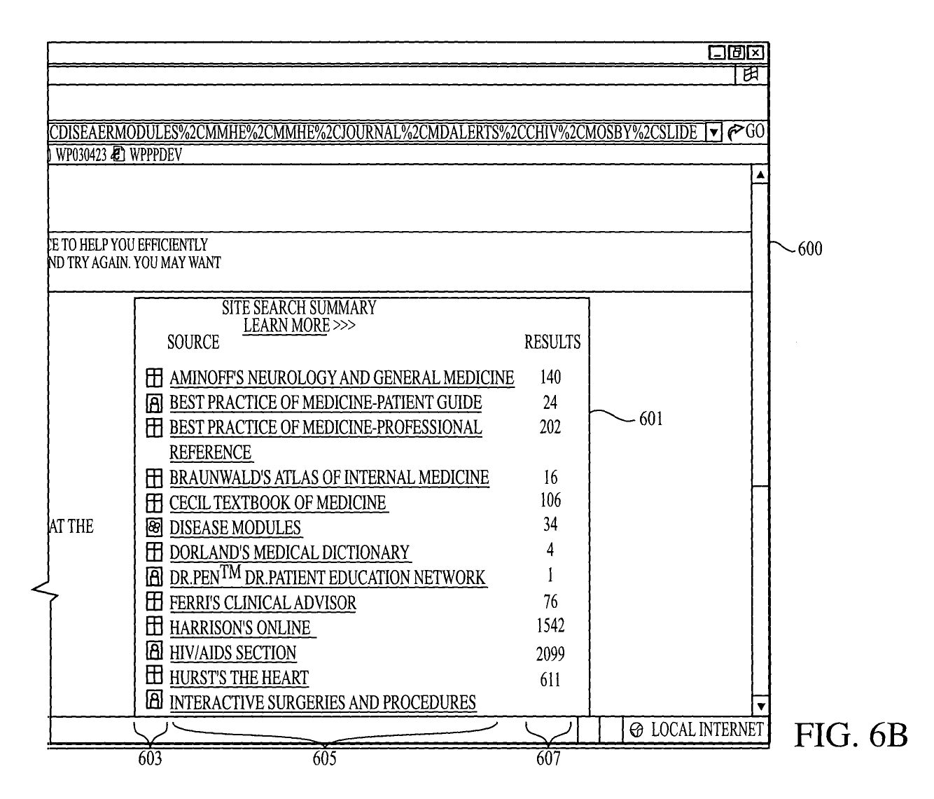

Reference is now made to FIG. 6, providing an example of a user interface for providing search results and a site search summary box in the system of the present invention. The user interface 600 provides a search results list 602, and a site search summary 601. The search results list 602 includes items listed by resource category 611. Each items list by resource category specifies the resource category, and lists the item 609 returned in the search results within that resource category. According to one or more embodiments of the present invention, the resource categories are implemented as buckets. The number of items displayed in the search results may be limited to, e.g., a maximum of two items per category, so that the display fits in a user screen. An item 609 displayed in the search results may include, for example, a title that optionally is hot-linked to the article (or other resource content), a short abstract of the article, and the URL optionally hot-linked to the article (or other resource content). The site search summary 601 is displayed in a visually separate manner, e.g. within a box. The site search summary 601 provides a summary of sites that were searched to obtain the search results. In this example, the site search summary provides a listing of source sites 605 (e.g., “The Merck Manual 17^{th} Edition,” “Mosby's Drug Reference,” etc.); for each source site, optionally includes an icon 603 corresponding to one of the search categories; and for each source site, optionally indicates the number of search results located within that source. The items provided in the search results are grouped, e.g., by source, with sources and results listed in, e.g., alphabetical order. The results included on the display (where the display is limited) may be determined, e.g., by source and date, and may be ranked according to relevance to the resource category per source.

The user may specify the term or terms to search, and optionally may specify the scope of the search. In the present example, the user interface includes a location to specify a search term 613, and a location to indicate the scope of the search (e.g., entire site, or specific category). The user interface for the search, which is a basic search in this example, may include an advanced search link 617 to one or more advanced searches.

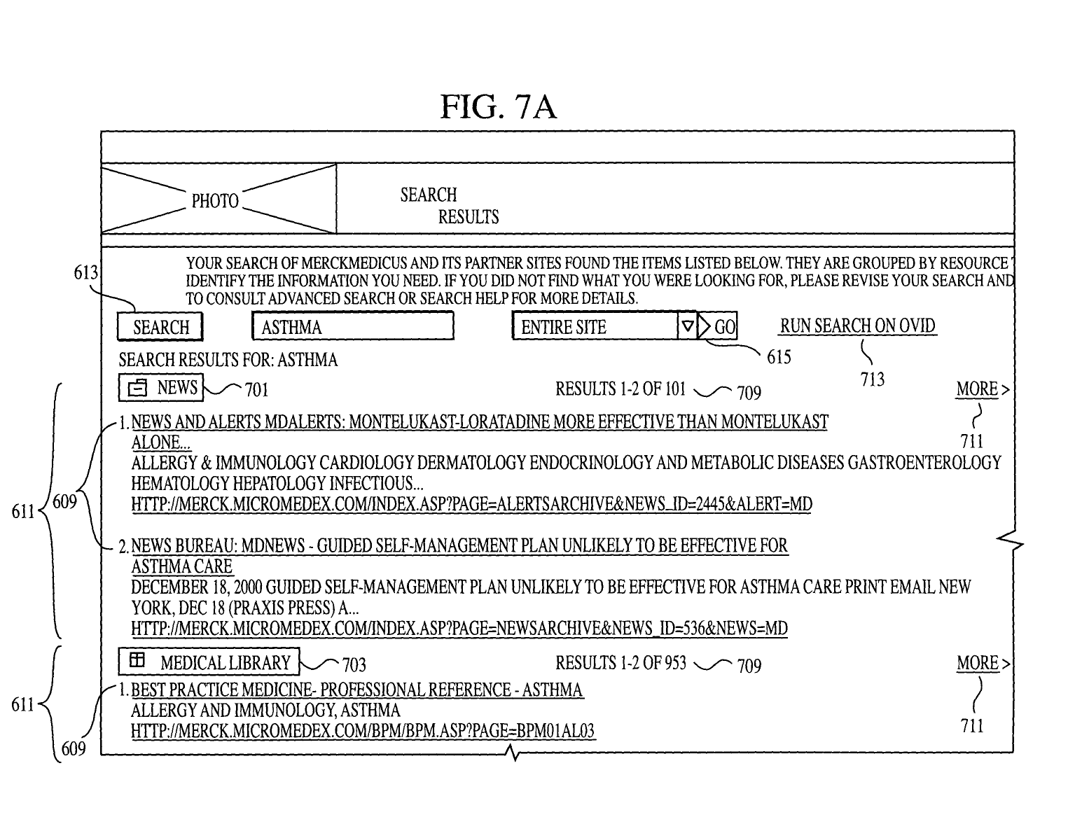

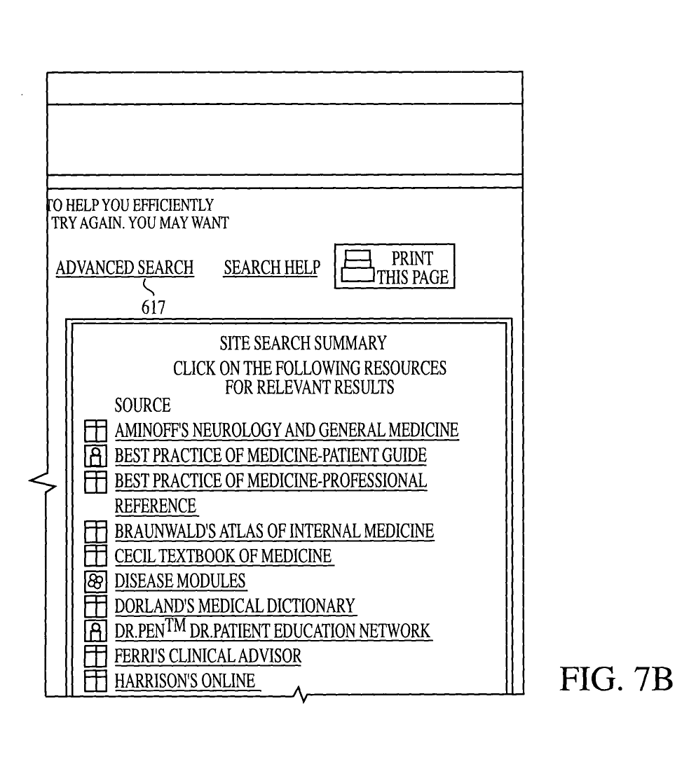

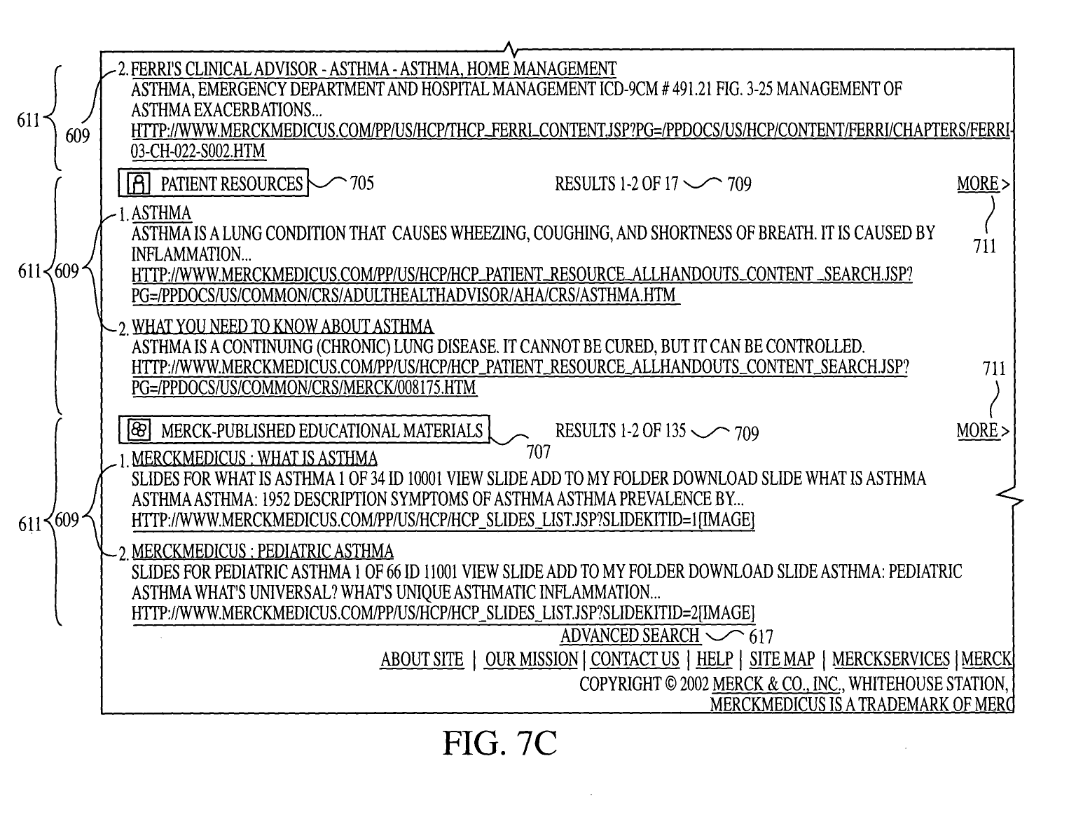

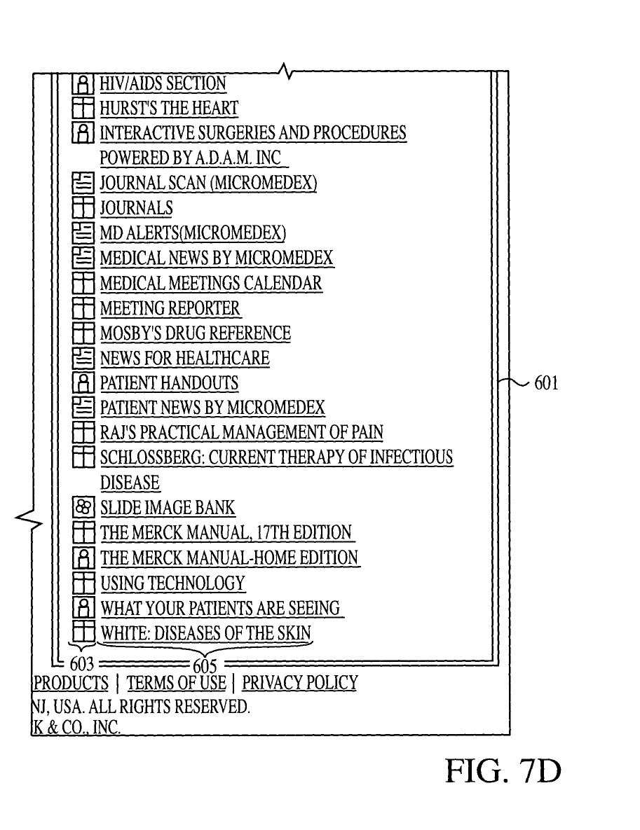

FIG. 7 illustrates in more detail another example of search results and an example site search summary, in this case an embedded box. In this example, a search was run on the term “asthma,” resulting in the example display. The search results are divided into categories, optionally implemented as buckets, which were previously selected based on a physician's intuitive categorization of medical literature. In this case, there are four categories: News 701, Medical Library 703, Patient Resources 705, and educational materials 707. The News category encompasses sources of medical news, e.g., “Medical News by Micromedex,” “News for Healthcare,” “MD Alerts (Praxis),” “Journal Scan (Praxis),” and/or other sources as desired. The Medical Library category encompasses more traditional medical sources, e.g., “The Merck Manual,” “Cecil Textbook of Medicine,” “Best Practice of Medicine by Praxis.MD,” “Dorlands Illustrated Medical Dictionary,” “Mosby's GenRx,” “Harrison's Online,” “New England Journal of Medicine,” other reference manuals, medical journals, and/or other sources as desired. The Patient Resources category encompasses healthcare sources that are directed to non-professionals, e.g., “The Merck Manual-Home Edition,” patient guides, “Best Health Guide by Praxis.MD,” and/or other sources as desired. The educational materials category encompasses sources that are intended to educate, or to assist in educating, professionals, e.g., disease modules with training on diseases, slide image bank with PowerPoint™ images and lecture notes, etc. Categories and/or sources therein may be added, omitted, and/or combined, if desired, in other embodiments of the invention.

Each list of search results by category also lists the number of results 709 for that category. The listing may be expanded, e.g., by clicking on the “More” button 711. The user may select to run the search on an alternate search engine, e.g., Ovid 713.

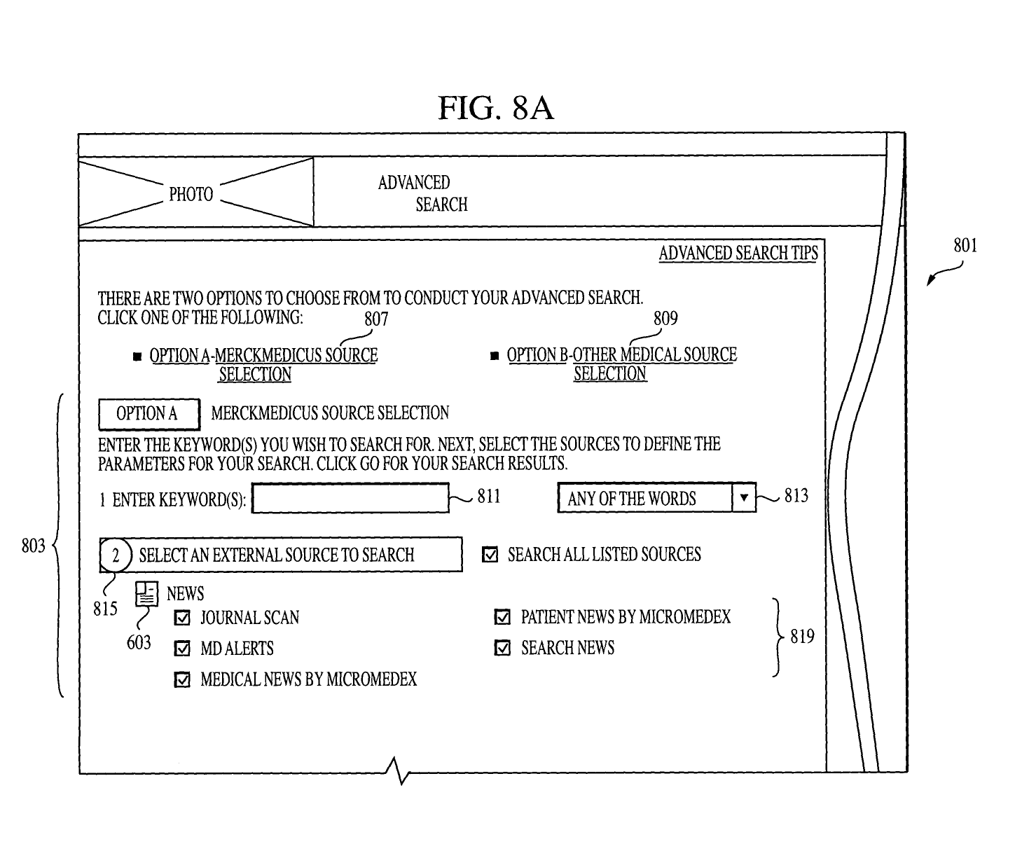

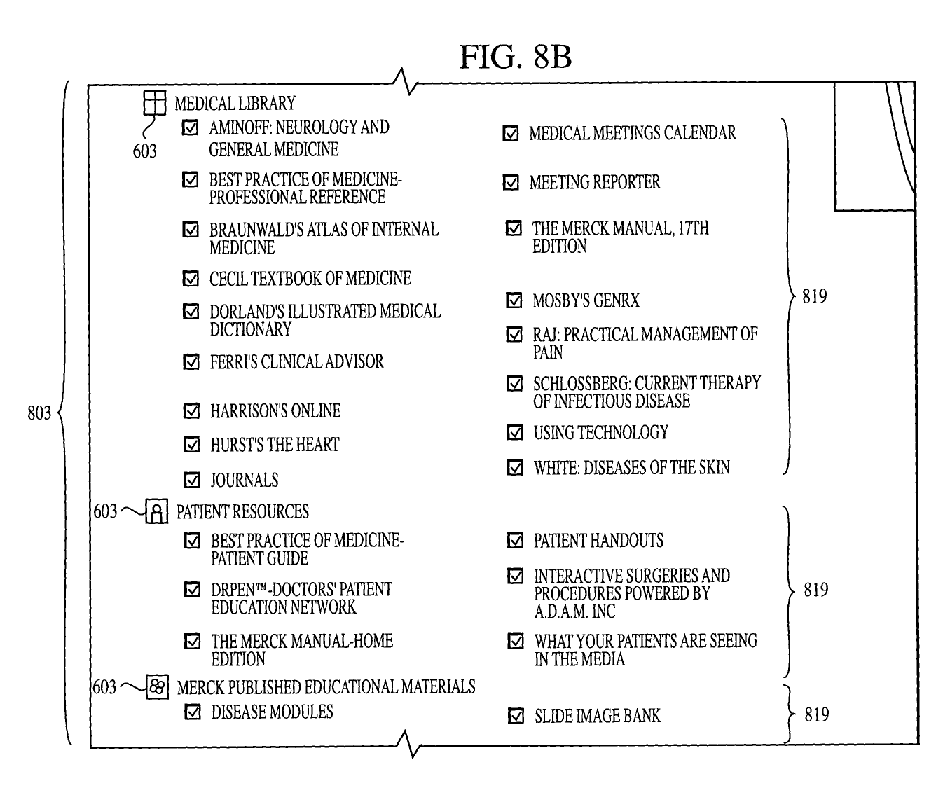

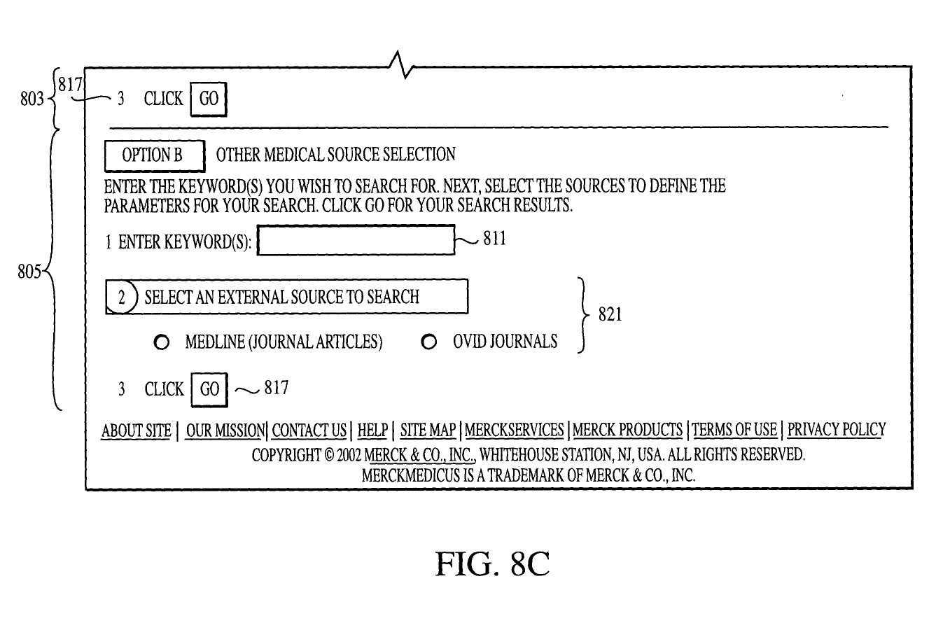

According to one or more embodiments of the present invention, one or more “advanced” searches are included. For example, FIG. 8 is a user interface illustrating two advanced searches for conducting a search. The optional searches in this example include a search for limiting the selection of sources 807 normally included in the search according to the invention, and a search for specifying other external sources 809, e.g., those not normally included in the search.

The search with limited source selection 803 includes entry of keyword(s) 811, and a more advanced search definition 813, e.g., all terms, any term, etc. The limited source selection search 803 also includes a specification of the sources to search 815; advantageously, the sources can be listed in a checklist. In the present example, the sources are grouped by resource category 819, and each category includes its associated category icon 603. Once the user has defined the desired search, the user may initiate the search, e.g., by clicking the “Go” button 817. The search results for the advanced search may be delivered in the same format as the results for the previously described basic search and/or in other standard formats.

The other external source search 805 includes a specification of search term, terms or phrase 811, and a selection of an external source to search 821. Once the user has defined the desired search, the user may initiate the search, e.g., by clicking the “Go” button 817. Again, the search results for this advanced search may be delivered in the same format as for the basic search.

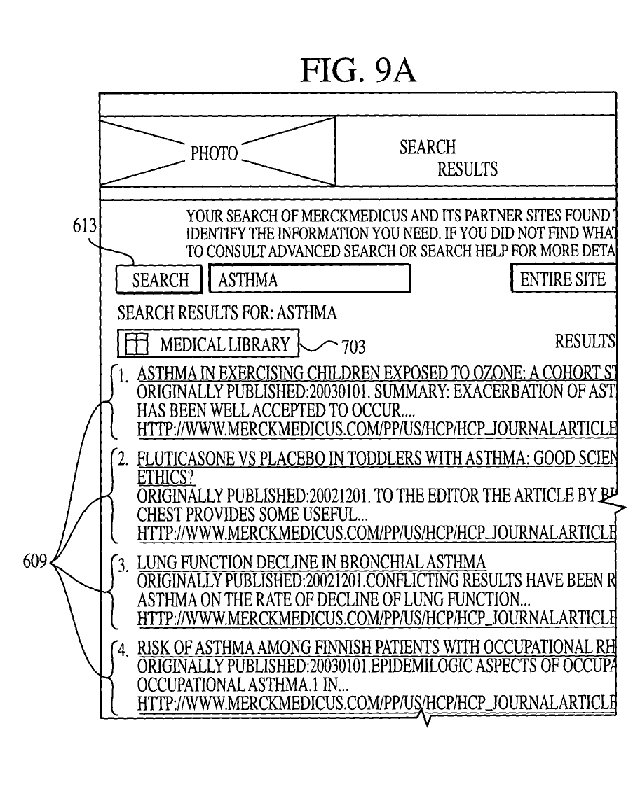

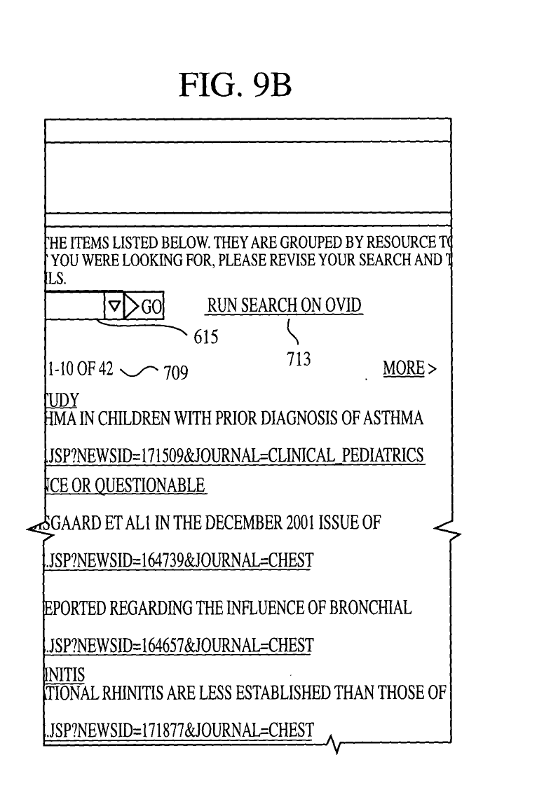

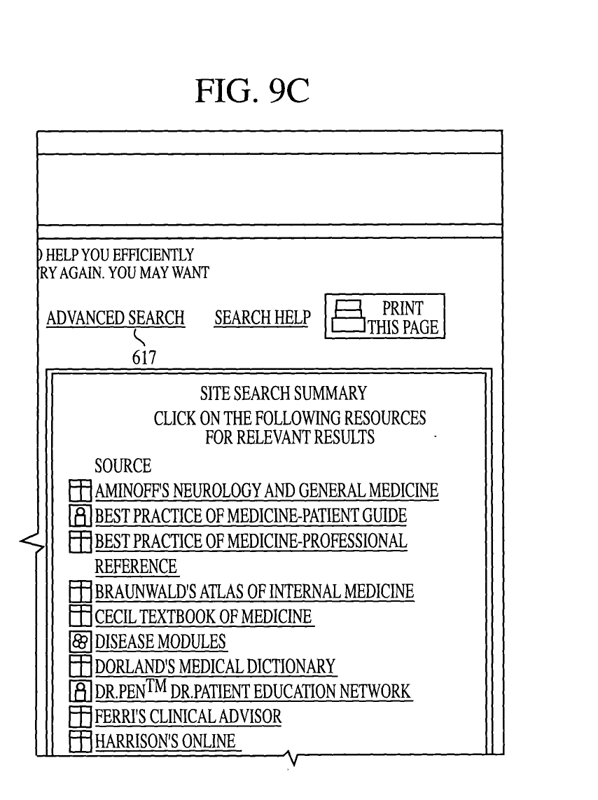

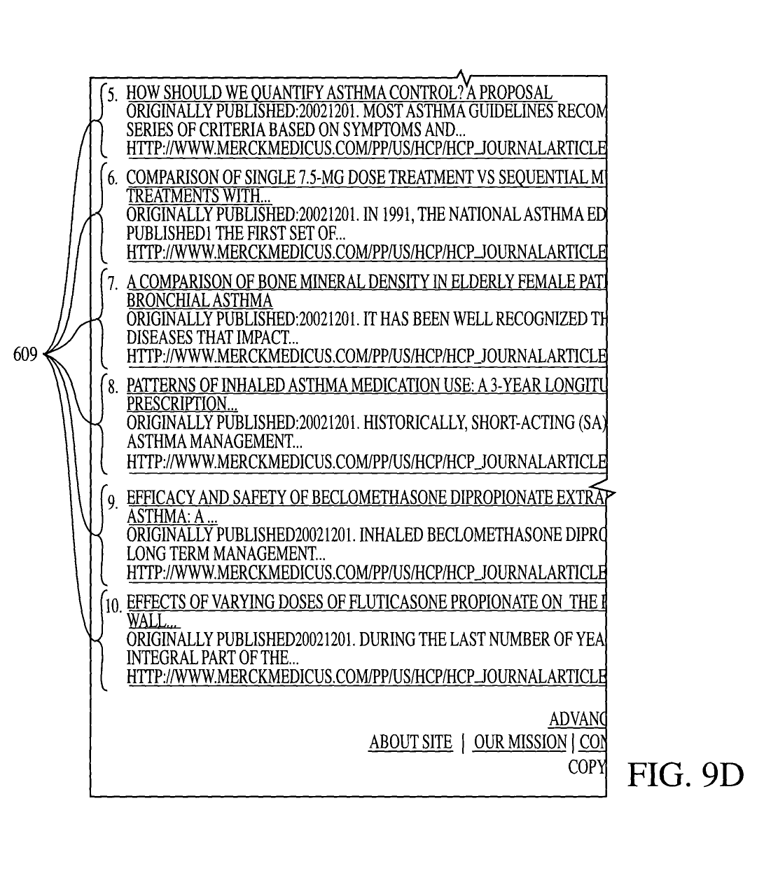

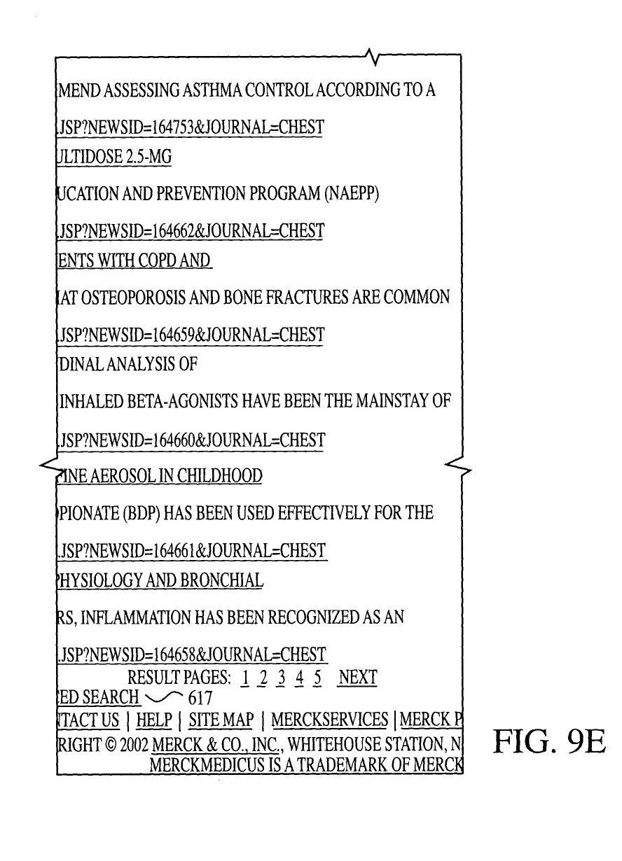

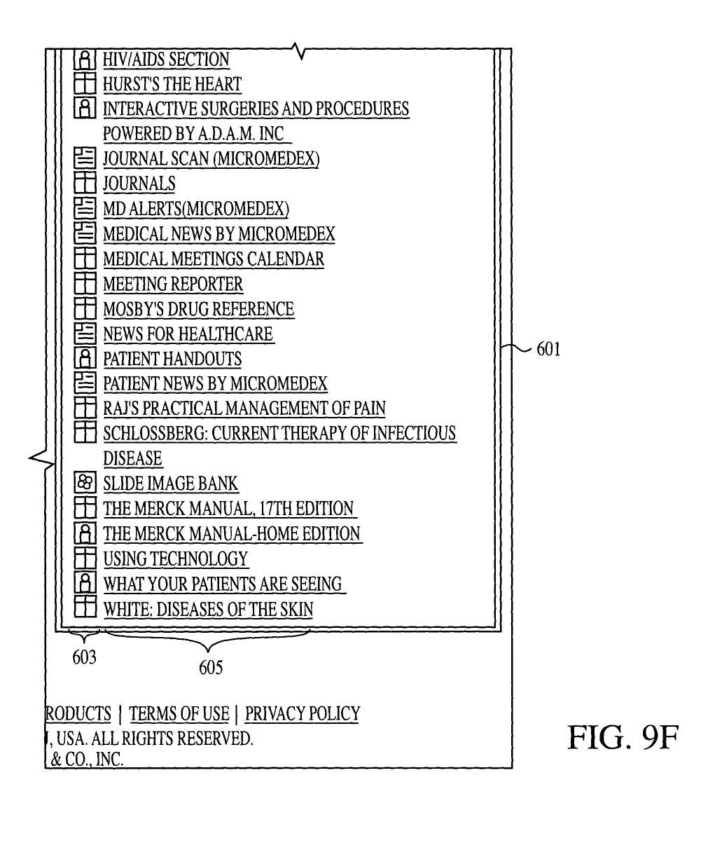

Reference is now made to FIG. 7, illustrating example search results, and FIG. 9, illustrating example search results after utilizing the search summary box to drill down to further detail in a category. The drill down example of FIG. 9 resulted from the user obtaining search results, e.g., those illustrated in FIG. 7, including a site search summary 601. In this example, the user selected, within the site search summary 601, the source “Journals.” The source “Journals” in this example is associated with the “Medical Library” category, as shown by the adjacent icon 603. Having selected that source, the user is presented with the items listed in the search results for that source, i.e., “Journals,” as shown in FIG. 9. In this example, the user is provided with the full search results over multiple pages. The site search summary is displayed in this example, thereby allowing the user to select and display search results from another source and/or category. The user may choose to display all search results in any category by selecting the icon for that category; upon selecting the icon for the category, the user is presented with the search results for that category. In this way, the search results may be provided by category, within the category listed in order by a predefined preference (e.g., relevance); search results may be provided for a particular category; search results returned may be provided from a single source, listed in order by a predefined preference (e.g., relevance); an item returned in the search results may be reviewed; and/or the sources returning results and/or searched for results may be listed, e.g., in the site search summary box.

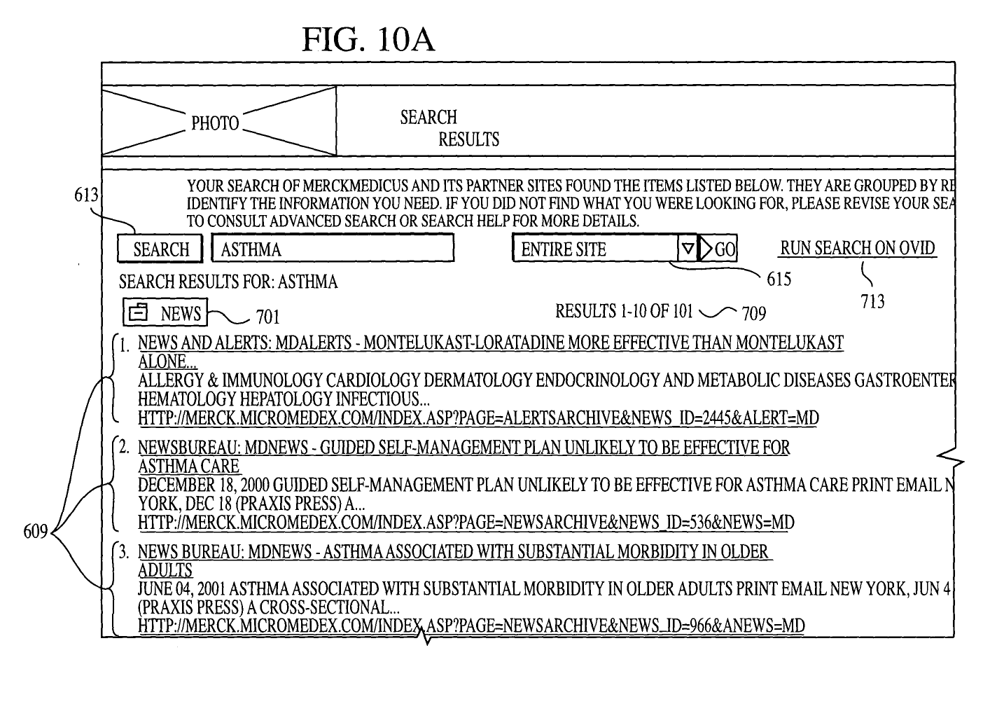

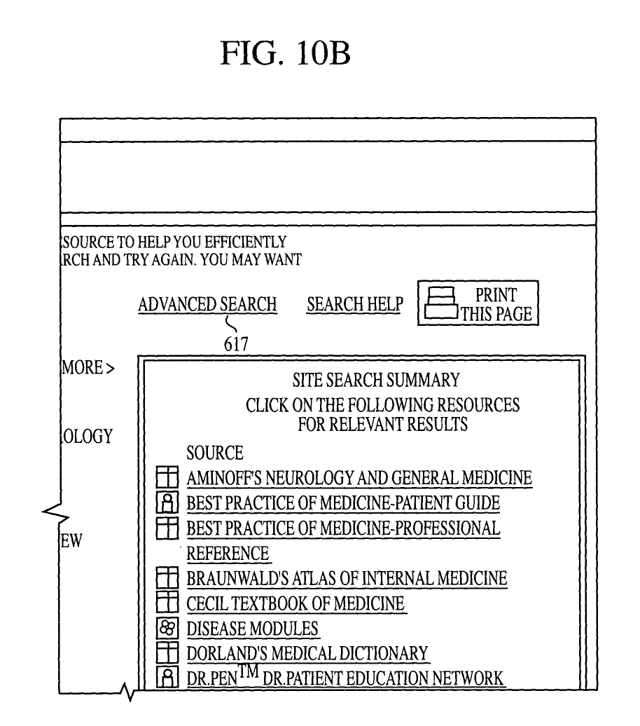

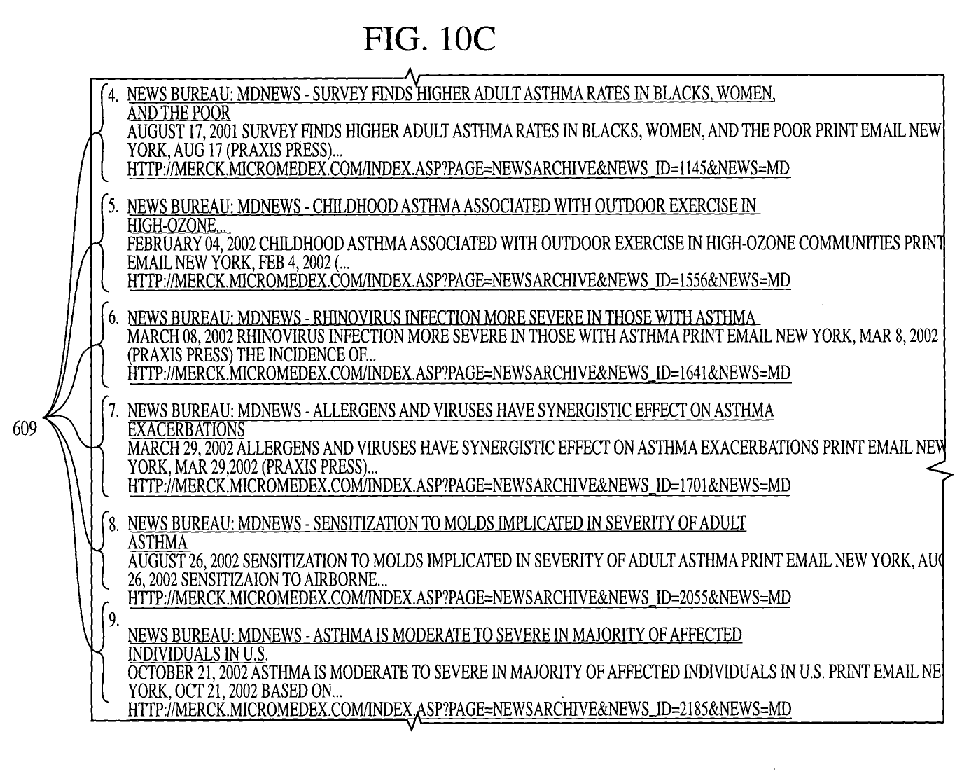

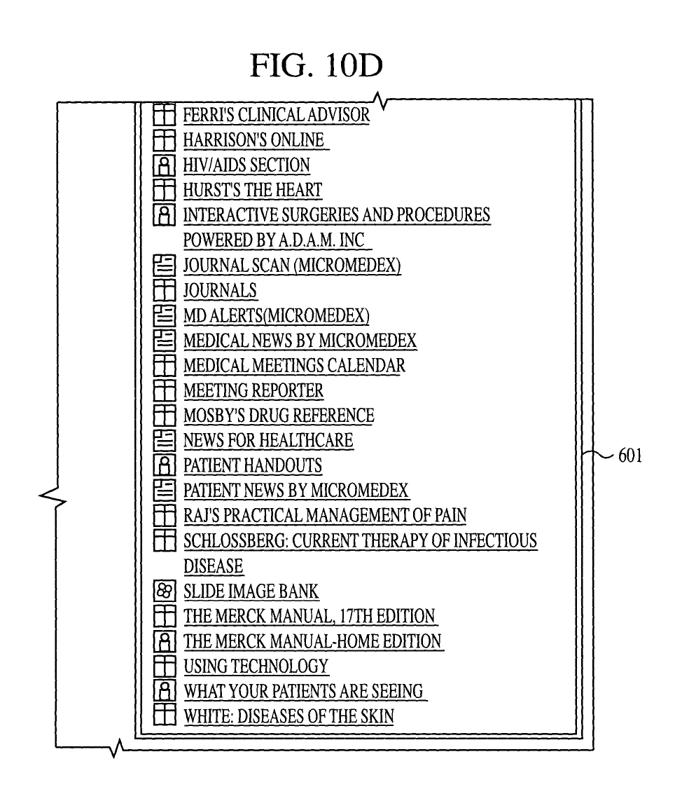

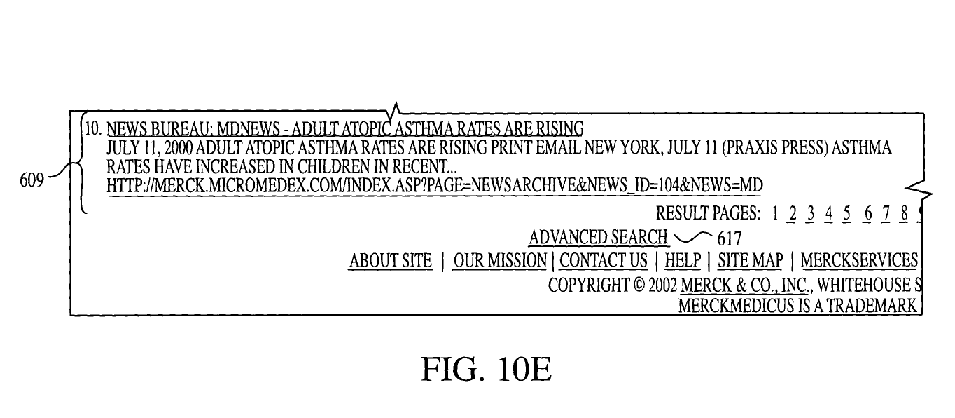

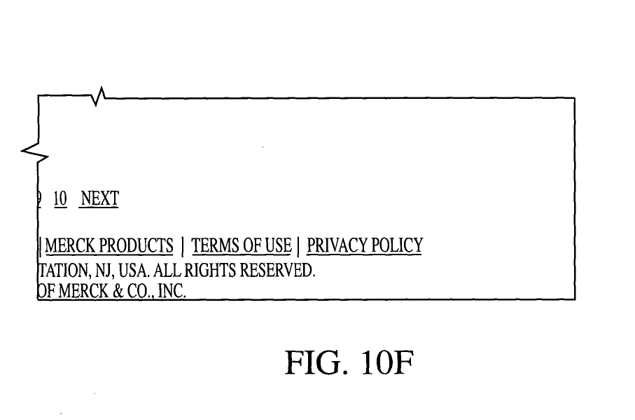

FIG. 10 illustrates an alternative screen, where the user selected to drill down to the resource “Medical News by Micromedex.” Here, the resource category 701 is “News”.

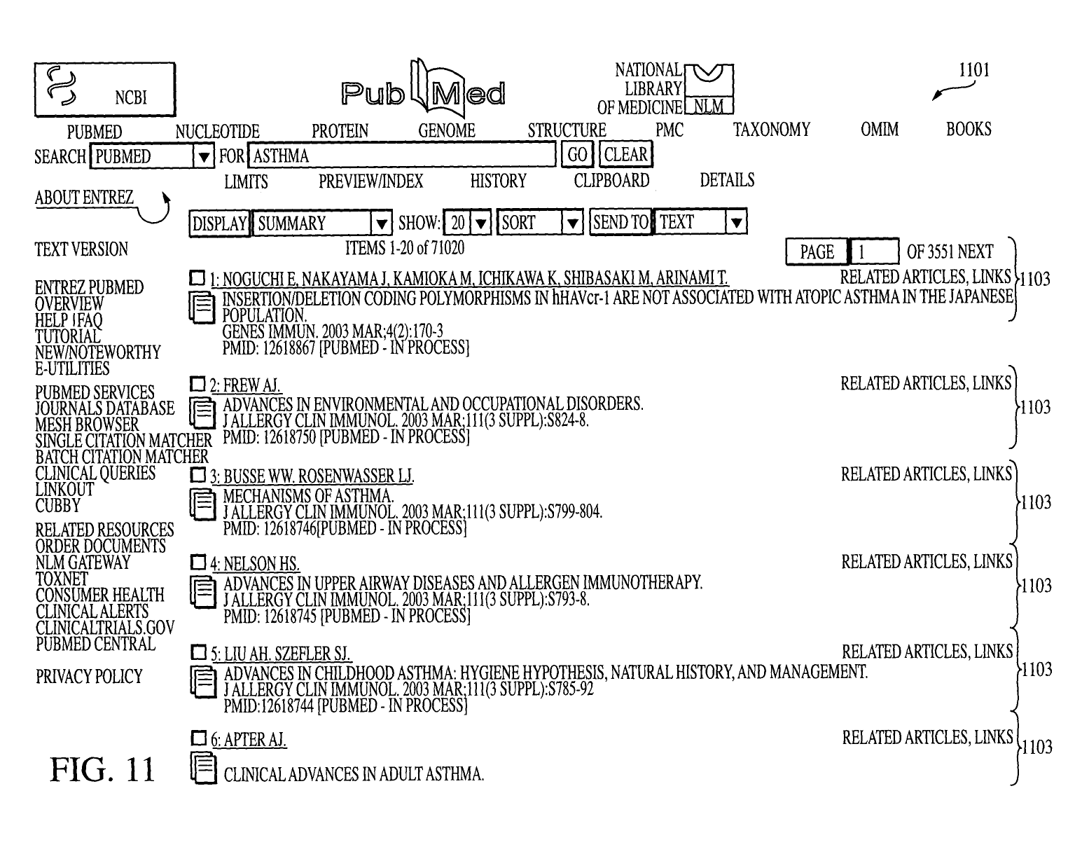

Reference is made to FIG. 11, illustrating an example user interface after the user selected an advanced search of external sources. The search parameters entered by the user are passed to the search engine for the external source, and the search results are displayed. Here, the site for the external source includes a search engine and the user is linked to the external source's search results page 1101. The external source search results include a listing of returned search items 1103.

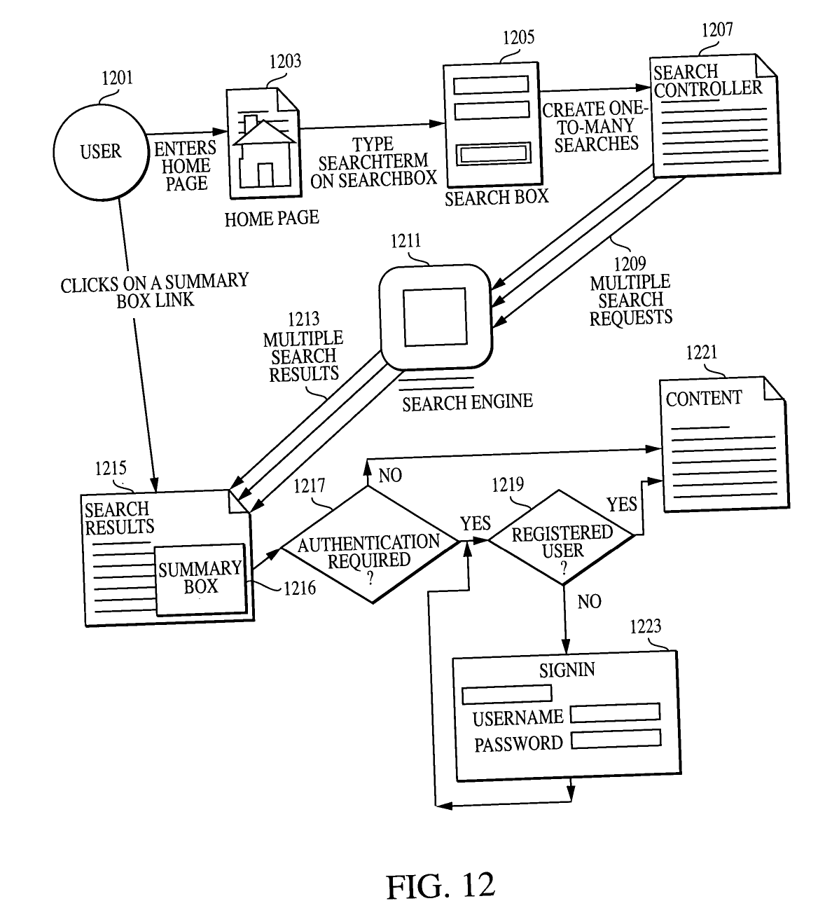

Reference is now made to FIG. 12, illustrating site search summary flow. The user 1201 has navigated to the site, e.g., the home page 1203, and has selected to utilize the search according to the invention. The user has typed in the search term within the search box 1205, including one or more of the resource categories in which to search. Upon submitting the search, actions are taken to produce the user's request search specific results page including the site search summary. A search controller 1207 creates the appropriate one or more search requests, e.g., including search term and specifying search sources within the resource category. For example, a search request, one for each category, may be created encompassing sources in each category. The search controller 1207 submits the one or more search requests to a search engine 1211. One example of an appropriate search engine is UltraSearch™ by Ultrasearch Inc. The search engine performs the requested searches of specified sources, and returns category specific sets of search results, which are listed in the user display 1215 by category. The user display 1215 includes the optional site search summary 1216. The site search summary quantifies the number of unique document results per each available source based on the keyword or phrase entered by the user. Every source containing at least one hit is displayed in the site search summary. Optionally, if the source is restricted to certain authenticated users, block 1217, the system checks whether the user is registered, block 1219, and if not, requests the user to login, block 1223. Some sources, for example, may be restricted to state licensed medical professionals residing in the United States. If the source is restricted and the user is appropriately registered, or if the source is unrestricted, the user may access the content 1221 of the resource. Optionally, the site search summary does not count source, and/or does not display information on sources, that the user cannot access due to restrictions.

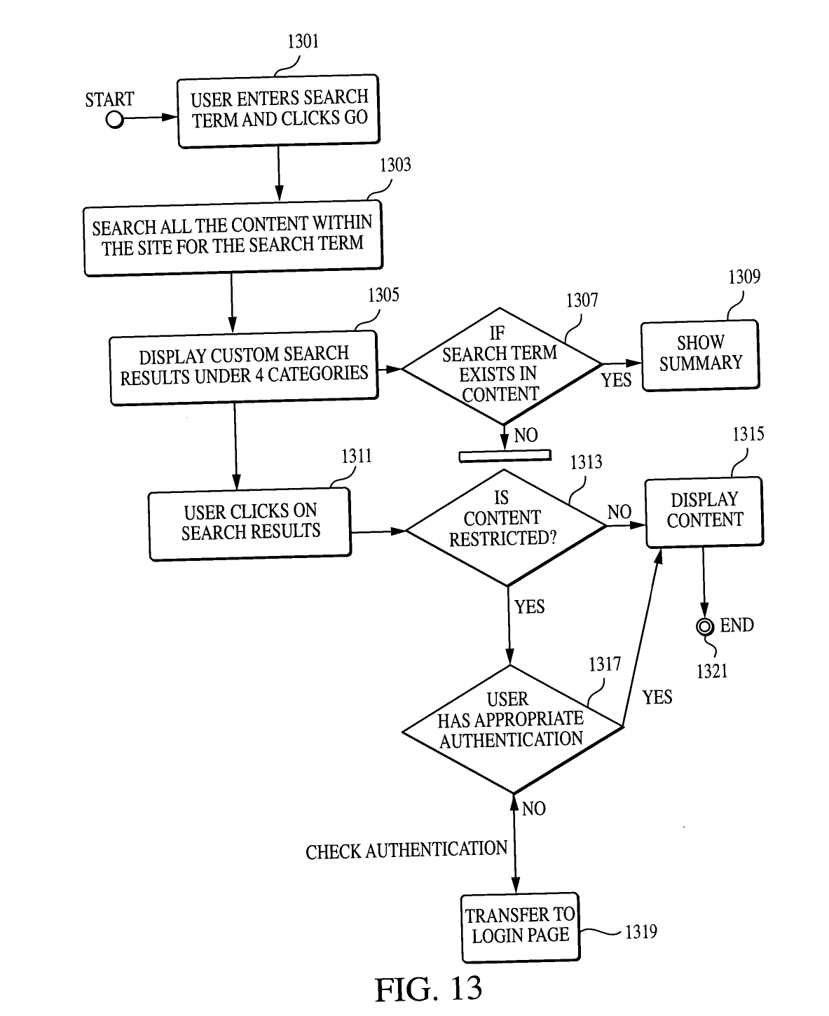

Although specific resource content may be made available for searching against, some sources may be restricted to defined authentication levels. For example, restrictions may be assigned by the purveyor of the source and/or dictated by a license for the source. An appropriate time for determining user authentication is at the time of result page creation; the URL link for any specific result may be created at that time if the authentication level is appropriate. In the medical field, there are typically three authentication levels based on the type of professional, corresponding to conceptual levels of access to various sources: (1) registered health care professional, (2) MD or DO, and (3) non-registered health care professional. The user may be assigned an authentication level during a registration process at which time the user indicates their type of profession. During the registration process, the system optionally queries the user for licensure information, which it then verifies. As illustrated in FIG. 13, when the user enters the search terms and initiates the search, block 1301, the search engine is requested to perform custom searches of all selected content within the site for the search term, block 1303. The items returned in the custom search results are displayed under the categories, in this example, four categories, block 1305. As part of displaying the search results, if a search term exists in a content resource, block 1307, e.g., a textbook or a journal series, then at block 1309 the system displays the summary. If the user selects one of the items in the search results, block 1311, to view the content, then the level of restriction of the content is determined, block 131. If the content is restricted and the user does not have appropriate authentication 1317, an alert message is displayed, e.g., stating the nature of the user's authentication status within the site at that time. At block 1319, the user is then redirected to a login/registration page and subsequent verification of authentication. If the authentication status is appropriate to the content restriction, block 1313, then access is granted and the content the user wishes to view is displayed, block 1315. Other sequences and/or combinations of blocks may be utilized and/or performed in accordance with the present invention.

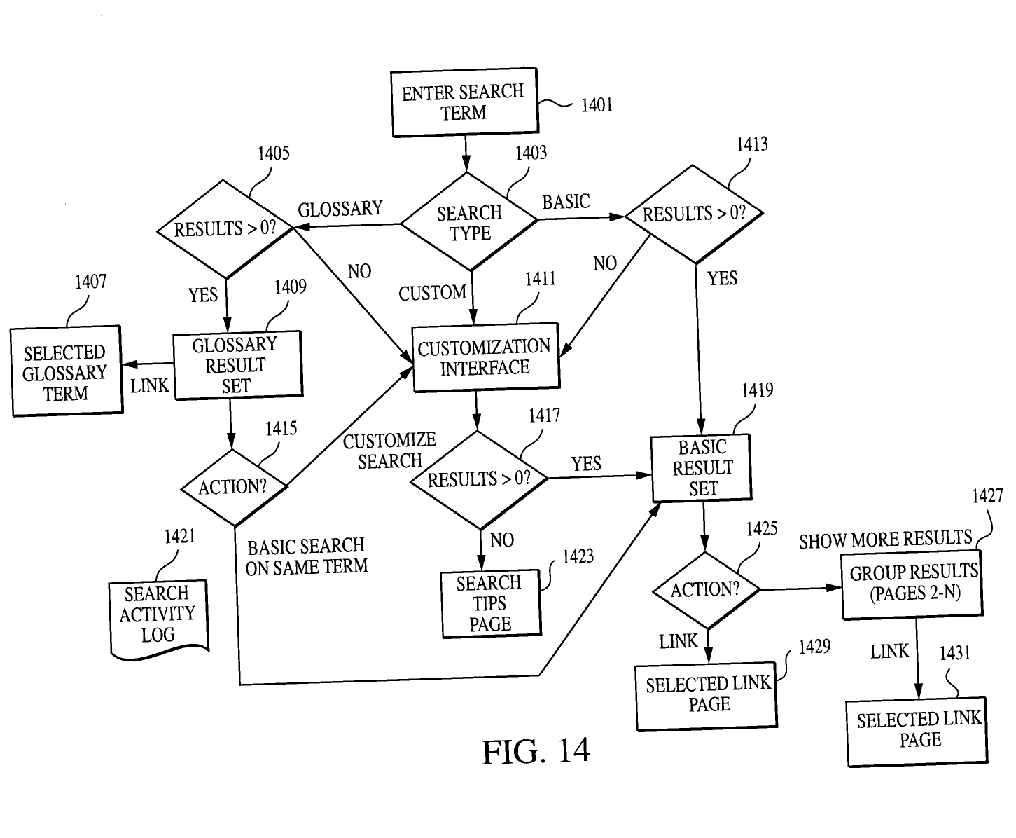

Optionally, the invention allows users to submit simple and advanced searches. In the example shown in FIG. 14, one or more embodiments of the invention allows the user to perform search via a glossary of search terms, a custom search, or a basic search. The simple search may be a text-only type-in box and dropdown-box allowing a user to specify the search term and optionally search scope. The advanced search may, for example, provide the user with ways of specifying not only search terms, but also selections of the resources to search. Optionally, the search may submit and retrieve search results from other Internet search applications where possible. Optionally, the search may accommodate Boolean operators. At block 1401, the user enters the desired search term. Depending on the type of search, block 1403, the system will submit and retrieve results for a custom search, a glossary search, or a basic search. If a glossary search was requested, and if there are results, block 1405, the system displays that result set, block 1409. If the user selects one of the items returned from the search, the system links to the selected glossary term, block 1407. If the user takes some other search action, block 1415, the system proceeds accordingly to either the customization search interface, block 1411, or to the basic search result set, block 1419.

For a custom search, the system displays the customization interface, block 1411. If there are no search results, the system displays the search tips page, block 1423. Otherwise, if there are results, the system displays the basic result set page, block 1419. Likewise, if the user submitted a basic search request, and if there are search results, block 1413, the basic result set page, block 1419, is displayed.

From the basic result set page, block 1419, the system determines whether the user has taken some action, block 1425. If the action is a link, then at block 1429, the user is linked to the selected linked page. If the action taken is to show more results, then the system groups the results by category, block 1427; the user may then select a link and connect or link to the selected page 1431. Other sequences and/or combinations of blocks may be utilized and/or performed in accordance with the present invention.

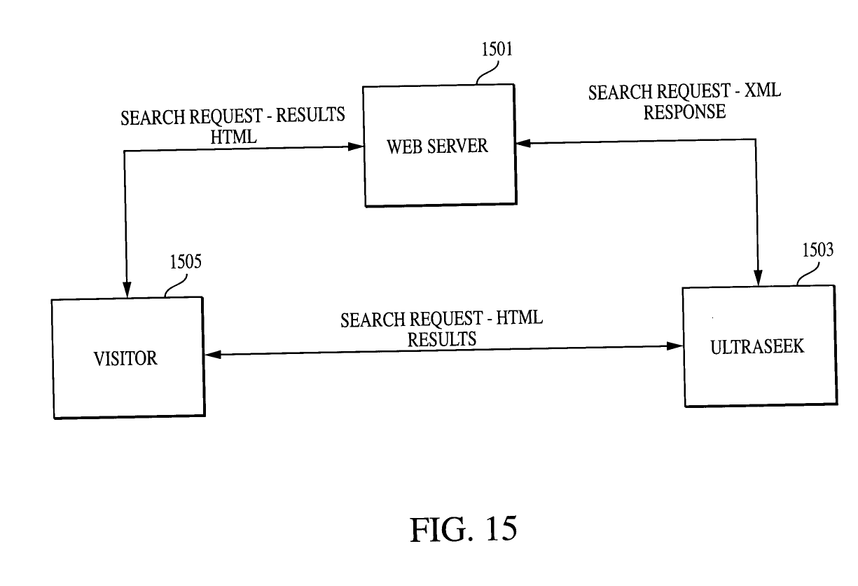

Reference is now made to FIG. 15 illustrating one or more embodiments of a basic architecture for the search according to the present invention, including a web server 1501, a computer for a visitor to the web site 1505, and a search engine 1503, e.g., Ultraseek™, including optional paths for HTML and XML. The visitor 1505 submits a search request to the web server 1501. An application running on the web server makes the appropriate requests to the search engine, e.g., by invoking the search engine. The search engine may be running on the same or a different web site. The search engine 1503 returns XML search responses to the web server 1501, which forwards the responses to the visitor 1505; whereas the search engine 1503 returns HTML search results back to the visitor 1505. The search responses advantageously are segmented to correspond directly to the categories displayed in the user interface, with each grouping identifying the total number of matches, ranking, and relevancy score. The sources and/or categories may default to all available sources and/or categories; may be specific to user, e.g., based on user registration information; may be customized by a registered user to default settings; and/or may be specific to other user information, e.g., licensure status.

Where a search engine such as Ultraseek™ is utilized, the network may be spidered (vs. scanning the filesystem). Original XML content may, if desired, be rendered as HTML pages for the spider, so that much of the synthetic metadata information may be harvested in the usual fashion from the rendered HTML documents themselves. The system may have previously requested the search engine to index the collections of resources that are searched; it is advantageous for the available resources to correspond to collections of resources indexed by the search engine.

When creating search indices, there are two groups of information:

(1) Information (relationships) to support query operations, e.g.,

Terms

Phrases and/or

Metadata (support for fielded search operators)

(2) Information to be presented in search results (e.g., an Ultraseek™ title record), e.g.,

Title

URL

Summary

Last-modified date

Size and/or

“Publisher”

Spidering has the advantage that it supports a wide variety of content types, e.g., HTML, XML, plain text, Microsoft™ Office™, Lotus™ SmartSuite™, PostScript™, Adobe™ Acrobat™ (e.g., PDF), FrameMaker™, etc.; most of which can be retrieved via a URL, e.g., via e.g., HTTP, FTP or HTTPS. An HTML page for a natural metadata retrieval and subsequent fielded search might be, for example,

<meta name=“scope” content=“hcp”>

After indexing, the example page can be retrieved via the query scope:hcp. The metadata/field relationship thus roughly incorporates the concepts of “scope” (e.g., HCP vs. CNS) and “source” (unified collection of related resources, e.g., a web site, PDR Online, NEJM). For search purposes, the “scope” may be required based upon the user's profile information; the profile information could be submitted within the query by the initial search form. The “source” information may be accumulated (e.g., one, several or all sources) also based upon passed information originating in the user's profile. If scope and source meta tags are not included explicitly within the rendered HTML documents but may be programmatically determined with available metadata, the indexer may be employed to synthetically develop the desired metadata and field relationships at index time.

Within the document body content, it may be useful to employ the stop/start index tag pairs, which may have the advantage of focusing the indexer's attention on unique document content and avoiding redundant indexing of common wrapper content, e.g., copyright information. An example FAQ is:

http://www.ultraseek.com/support/docs/faqs/faq052.htm

In accordance with one or more optional embodiments, the indexed content may be placed in a single comprehensive collection. The advantage is that this reduces the amount of complexity to be managed, and keeping a common, universal set of root URLs, filters, network setting, tuning parameters, etc. may be easily done within a single collection. Multiple collections, however, permit the setting of alternative tuning parameters, e.g., the periodicity of spider visits to dynamically generated content in a particular source.

A query result may be retrieved via, e.g., an HTTP GET request. The type of search results, e.g., HTML or XML, may be determined by the search form. A typical HTML result URL might be, for example

http://[Ultraseekhost:port]/query.html?qt=[queryterm]&qp=[queryprefix]&nh=[# of hits]

A typical XML results URL might be, for example

http://[Ultraseekhost:port]/sqauery.xml?qt=[queryterm]&qp=[queryprefix]&nh=[# of hits]

The “qp” form variable may be used to establish “scope” and “source” parameters for a search:

. . . &qp=%2Bscope%3Ahcp&qp=source%3Aproducts&qp=source%3Apdronline . . .

where “%3a” is an escaped colon (:) character for use with the scope and source field search operators, and “%2B” is an escaped plus (+) character, the “requirement operator” within the implied Boolean search operator set. One or more embodiments of the present invention may provide for additional “qp” operators for specific search zones, and unique “nh” values for each zone.

It should be understood that the invention is described in connection with logical groupings of functions or resources. One or more of these logical groupings may be omitted from one or more embodiments, and still remain within the scope of the present invention. Likewise, functions may be grouped differently, combined, or augmented without parting from the scope of the invention. Similarly the present description may describe various databases or collections of data and information. One or more groupings of the data or information may be omitted, distributed, combined, or augmented, or provided locally and/or remotely without departing from the scope of the invention.

The user may be a physician, other healthcare professional and/or student in the medical field. Some of these users may be licensed for a specific practice, and the licensure may be verifiable. The system may provide the user with expanded online access to high quality healthcare resources. The system may respond to the shifting needs of healthcare professionals, who are constrained to find practical ways to access information and services relevant to their practices, despite their business schedules and geographic constraints. Further, the present invention is intended to provide seamless access to such information.

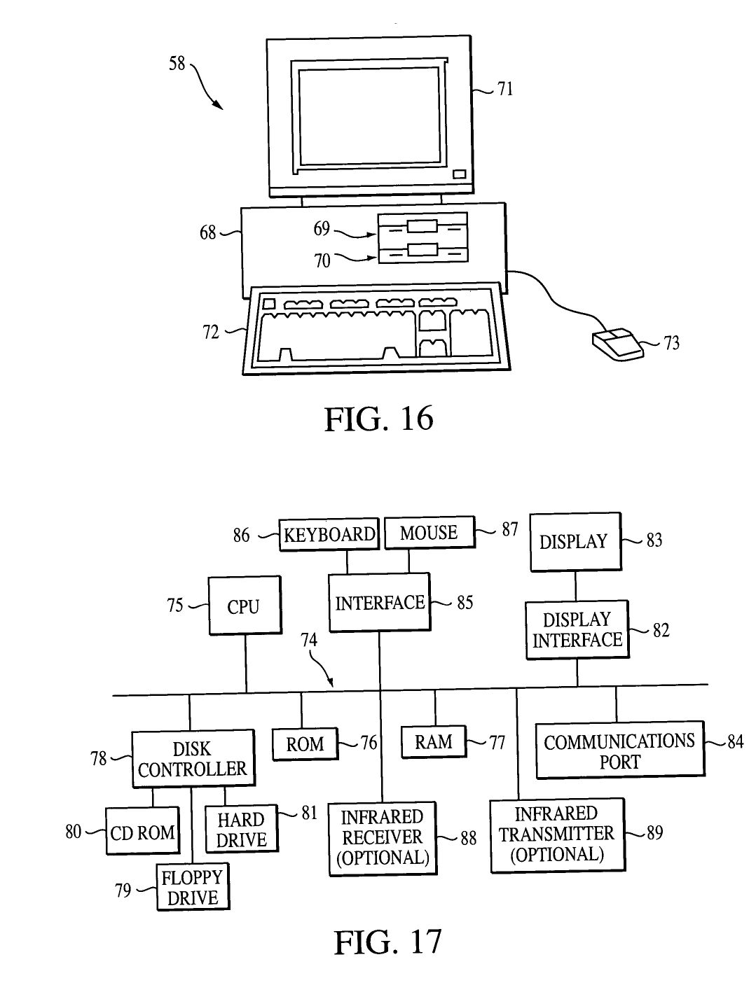

FIG. 16 is an illustration of a computer 58 used for implementing the computer processing in accordance with a computer-implemented embodiment of the present invention. The procedures described above may be presented in terms of program procedures executed on, for example, a computer or network of computers.

Viewed externally in FIG. 16, computer 58 has a central processing unit (CPU) 68 having disk drives 69, 70. Disk drives 69, 70 are merely symbolic of a number of disk drives that might be accommodated by computer 58. Typically, these might be one or more of the following: a floppy disk drive 69, a hard disk drive (not shown), and a CD ROM or digital video disk, as indicated by the slot at 70. The number and type of drives varies, typically with different computer configurations. Disk drives 69, 70 are, in fact, options, and for space considerations, may be omitted from the computer system used in conjunction with the processes described herein.

Computer 58 also has a display 71 upon which information may be displayed. The display is optional for the computer used in conjunction with the system described herein. A keyboard 72 and/or a pointing device 73, such as a mouse 73, may be provided as input devices to interface with central processing unit 68. To increase input efficiency, keyboard 72 may be supplemented or replaced with a scanner, card reader, or other data input device. The pointing device 73 may be a mouse, touch pad control device, track ball device, or any other type of pointing device.

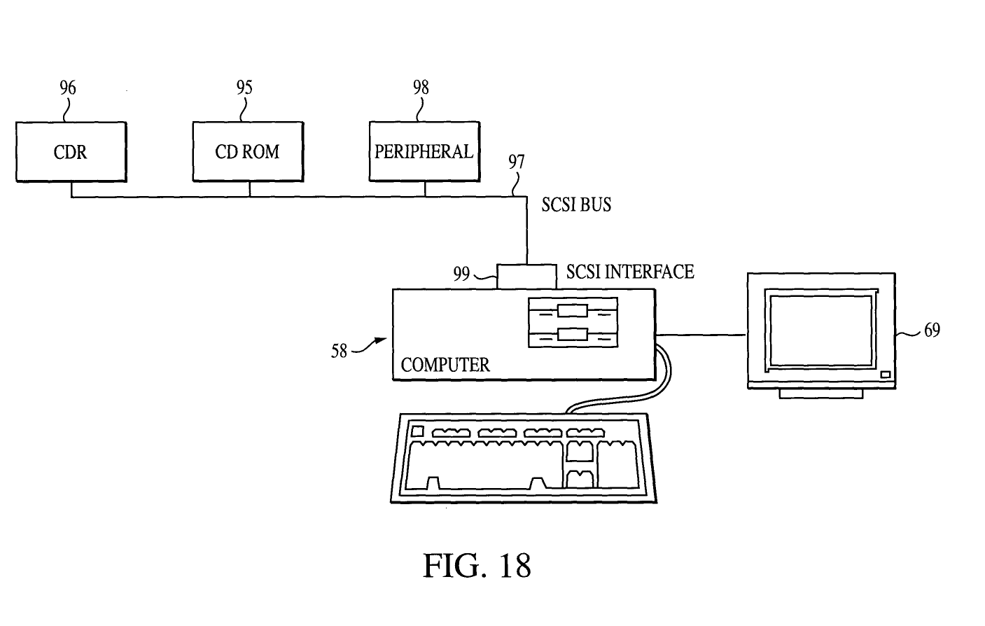

Alternatively, referring to FIG. 18, computer 58 may also include a CD ROM reader 95 and CD recorder 96, which are interconnected by a bus 97 along with other peripheral devices 98 supported by the bus structure and protocol. Bus 97 serves as the main information highway interconnecting other components of the computer. It is connected via an interface 99 to the computer 58.

FIG. 17 illustrates a block diagram of the internal hardware of the computer of FIG. 16. CPU 75 is the central processing unit of the system, performing calculations and logic operations required to execute a program. Read only memory (ROM) 76 and random access memory (RAM) 77 constitute the main memory of the computer. Disk controller 78 interfaces one or more disk drives to the system bus 74. These disk drives may be floppy disk drives such as 79, or CD ROM or DVD (digital video/versatile disk) drives, as at 80, or internal or external hard drives 81. As previously indicated these various disk drives and disk controllers are optional devices.

A display interface 82 permits information from bus 74 to be displayed on the display 83. Again, as indicated, the display 83 is an optional accessory for a central or remote computer in the communication network, as are infrared receiver 88 and transmitter 89. Communication with external devices occurs using communications port 84.

In addition to the standard components of the computer, the computer may also include an interface 85, which allows for data input through the keyboard 86 or pointing device, such as a mouse 87.

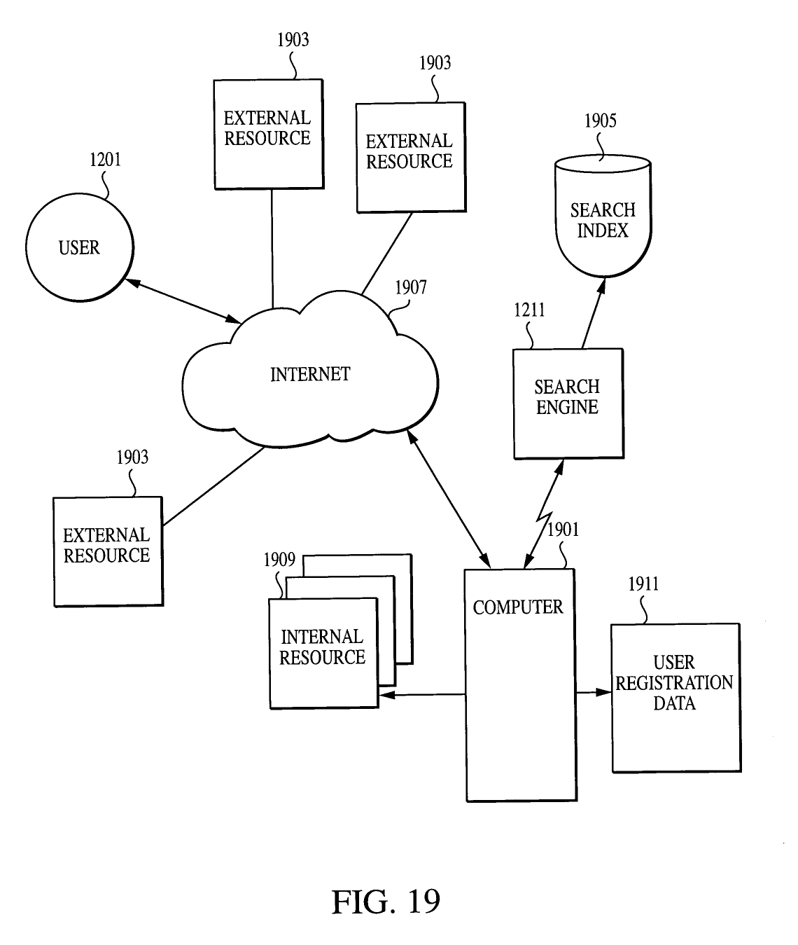

Reference is now made to FIG. 19, illustrating one example of a network for use in connection with the search system and/or method for providing source specific sets of search results and a site search summary, according to the present invention. The user 1201 wishing to search various resources, including external resources 1903 and internal resources 1909 may access the computer 1901 on which the search system operates, for example via the Internet 1907. The user's search request is submitted to the computer 1901, where it is transmitted to the search engine 1211 in an appropriate form including, e.g., search term(s) and scope of source(s) to be searched in accordance with the categories. The search engine 1211 searches for resource content in the specified scope including the specified search terms, optionally within the search index 1905. If using the search index 1905, the computer 1901 has previously instructed the search engine 1211 to periodically build and/or update an appropriate search index 1905 directed to sets of external and internal sources 1903, 1909 by categories. The search results are returned (in this example) from the search engine 1211 to the computer 1901, including sets of search results by category. The computer 1901 transmits the search results to the user 1201, including sets of search results by category and the site search summary. The computer 1901 optionally checks the user registration data 1911 for the user to ensure that the user is permitted to access any sources that are restricted and that are referenced in the search results.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

As one example, the system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, and/or any other method of communicating between computers and/or users. Moreover, the processing could be controlled by a software program on one or more computer systems or processors, or could even be partially or wholly implemented in hardware.

The user interfaces may be developed in connection with an HTML display format. Although HTML is utilized in the illustrated examples, it is possible to utilize alternative technology for displaying information, obtaining user instructions and for providing user interfaces. The invention has been discussed in connection with particular examples. However, the principles apply equally to other examples and/or realizations. Naturally, the relevant data may differ, as appropriate.

Further, this invention has been discussed in certain examples as if it is made available to a single user. The invention may be used by numerous users, if preferred. The system used in connection with the invention may rely on the integration of various components including, as appropriate and/or if desired, hardware and software servers, database engines, and/or other content providers. The configuration may be, preferably, network-based and uses the Internet as a primary interface with the user.

The system according to one or more embodiments of the invention may store collected information and/or indexes of information in a database. An appropriate database may be on a standard server, for example, a small Sun™ Sparc™ or other remote location. The information may, for example, optionally be stored on a platform that may, for example, be UNIX-based. The various databases maybe in, for example, a UNIX format, but other standard data formats may be used.

Although the computer system is discussed as having a single computer, the system according to one or more embodiments of the invention is optionally suitably equipped with a multitude or combination of processors or storage devices. For example, the computer may be replaced by, or combined with, any suitable processing system operative in accordance with the principles of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on floppy disk, provided on CD Rom, provided on optical disk memory, etc.

Any presently available or future developed computer software language and/or hardware components can be employed in such embodiments of the present invention. For example, at least some of the functionality mentioned above could be implemented using Visual Basic, C, C++ or any assembly language appropriate in view of the processor being used. It could also be written in an interpretive environment such as Java and transported to multiple destinations to various users.

The many features and advantages of the embodiments of the present invention are apparent from the detail specification, and thus, it is intended by the appended claims to cover all such features and advantages of the invention that fall within the true spirit and scope of the invention. Further, since numerous modifications and variations were readily occurred to those skilled in the art, it is not desired to limit the invention to the exact construction and operation illustrated and described, and accordingly, all suitable modifications and equivalents maybe resorted to, falling within the scope of the invention.

What is claimed is:

1. A computer-implemented medical resource search method for providing source specific sets of search results and a site search summary to a user including at least one of a physician and a healthcare provider, said search method comprising at least one of the sequential, non-sequential and sequence independent steps of:
(A) generating, responsive to a search request received from the user, at least one search query, the search query including at least one search term and a scope of sources to be searched, wherein a plurality of sources correspond to one of a plurality of categories; and wherein a plurality of electronic resources correspond to each of said plurality of sources;
(B) performing, responsive to the at least one search query, a search for the at least one search term in the plurality of electronic resources corresponding to the scope of sources;
(C) returning at least one set of search results, said at least one set of search results having a first indication of resources responsive to said at least one search query;
(D) displaying, responsive to the at least one set of search results returned, the at least one set of search results to the user, including a first display of the at least one set of search results by category; and a second display of a site search summary, including data representative of each source of the plurality of sources searched, and data representing the category corresponding to each source of said plurality of sources searched;
(E) displaying, responsive to a first selection of the category in at least one of said first display and said second display, the at least one set of search results corresponding to said category;
(F) displaying, responsive to a second selection of at least one of said plurality of sources searched, in at least one of said first display and said second display, the at least one set of search results in said at least one of said plurality of sources; and
(G) displaying, responsive to a third selection of one of said plurality of electronic resources in said at least one set of search results, content corresponding to said one of said plurality of electronic resources.

2. The method of claim 1, further comprising the step of checking a registration data for the user to ensure that the user is permitted access to a source that is restricted and that corresponds to one of said responsive plurality of electronic resources, and if the user is not permitted access, excluding the source from at least one of the displaying steps.

3. The method of claim 1, wherein said search uses at least one search index for the search engine, and further comprising the step of instructing the search engine to update the at least one search index directed to the plurality of sources by categories.

4. The method of claim 1, wherein said at least one set of search results further has, for each of said plurality of electronic resources, a second indication of at least one of: category, source, location, title and summary.

5. The method of claim 1, wherein said data representing the category in said second display includes an icon representing the category, and the first selection is of at least one of the category and the icon representing the category.

6. The method of claim 1, wherein the plurality of categories include at least one of medical news, medical library, and medical profession.

7. A computer-implemented medical resource search method for providing source specific sets of search results and a site search summary to a user including at least one of a physician and a healthcare provider, said search method comprising at least one of the sequential, non-sequential and sequence independent steps of:
(A) generating, responsive to a search request received from the user, at least one search query, the search query including at least one search term and a scope of sources to be searched, wherein a plurality of sources correspond to one of a plurality of categories including at least one of medical news, medical library, and medical profession; and wherein a plurality of electronic resources correspond to each of said plurality of sources;
(B) performing, responsive to the at least one search query, a search for the at least one search term in the plurality of electronic resources corresponding to the scope of sources, said search using at least one search index for the search engine;
(C) returning at least one set of search results, said at least one set of search results having a first indication of resources responsive to said at least one search query, and for each of said plurality of electronic resources a second indication of at least one of: category, source, location, title, and summary;
(D) displaying, responsive to the at least one set of search results returned, the at least one set of search results to the user, including a first display of the at least one set of search results by category; and a second display of a site search summary, including data representative of each source of said plurality of sources searched, an icon representing the category corresponding to each source of said plurality of sources searched, and a number of resources in each source of said plurality of sources searched responsive to the search query;
(E) displaying, responsive to a first selection of at least one of the category and the icon for the category in at least one of said first display and said second display, the at least one set of search results corresponding to said category;
(F) displaying, responsive to a second selection of at least one of said plurality of sources searched, in at least one of said first display and said second display, the at least one set of search results in said at least one of said plurality of sources;
(G) displaying, responsive to a third selection of one of said plurality of electronic resources in said at least one set of search results, content corresponding to said one of said plurality of electronic resources;
(H) checking a registration data for the user to ensure that the user is permitted access to a source that is restricted and that corresponds to one of said responsive plurality of electronic resources, and if the user is not permitted access, excluding the source from at least one of the displaying steps; and
(I) instructing the search engine to update the at least one search index directed to the plurality of sources by categories.

8. A computer-implemented medical resource search system for providing source specific sets of search results and a site search summary to a user including at least one of a physician and a healthcare provider, said search system comprising:
(A) means for generating, responsive to a search request received from the user, at least one search query, the search query including at least one search term and a scope of sources to be searched, wherein a plurality of sources correspond to one of a plurality of categories; and wherein a plurality of electronic resources correspond to each of said plurality of sources;
(B) means for performing, responsive to the at least one search query, a search for the at least one search term in the plurality of electronic resources corresponding to the scope of sources;
(C) means for returning at least one set of search results, said at least one set of search results having a first indication of resources responsive to said at least one search query;
(D) means for displaying, responsive to the at least one set of search results returned, the at least one set of search results to the user, including a first display means for characterizing the at least one set of search results by category; and a second display means for characterizing a site search summary, including data representative of each source of the plurality of sources searched, and data representing the category corresponding to each source of said plurality of sources searched;
(E) means for displaying, responsive to a first selection of the category in at least one of said first display means and said second display means, the at least one set of search results corresponding to said category;
(F) means for displaying, responsive to a second selection of at least one of said plurality of sources searched, in at least one of said first display means and said second display means, the at least one set of search results in said at least one of said plurality of sources; and
(G) means for displaying, responsive to a third selection of one of said plurality of electronic resources in said at least one set of search results, content corresponding to said one of said plurality of electronic resources.

9. The system of claim 8, further comprising means for checking a registration data for the user to ensure that the user is permitted access to a source that is restricted and that corresponds to one of said responsive plurality of electronic resources, and if the user is not permitted access, means for excluding the source from at least one of the displaying means.

10. The system of claim 8, wherein said search uses at least one search index for the search engine, and further comprising means for instructing the search engine to update the at least one search index directed to the plurality of sources by categories.

11. The system of claim 8, wherein said at least one set of search results further has, for each of said plurality of electronic resources, a second indication of at least one of: category, source, location, title and summary.

12. The system of claim 8, wherein said data representing the category in said second display includes an icon representing the category, and the first selection is of at least one of the category and the icon representing the category.

13. The system of claim 8, wherein the plurality of categories include at least one or medical news, medical library, and medical profession.

14. A computer-implemented medical resource search system for providing source specific sets of search results and a site search summary to a user including at least one of a physician and a healthcare provider, said search system comprising:
(A) means for generating, responsive to a search request received from the user, at least one search query, the search query including at least one search term and a scope of sources to be searched, wherein a plurality of sources correspond to one of a plurality of categories including at least one of medical news, medical library, and medical profession; and wherein a plurality of electronic resources correspond to each of said plurality of sources;
(B) means for performing, responsive to the at least one search query, a search for the at least one search term in the plurality of electronic resources corresponding to the scope of sources, said search using at least one search index for the search engine;
(C) means for returning at least one set of search results, said at least one set of search results having a first indication of resources responsive to said at least one search query, and for each of said plurality of electronic resources a second indication of at least one of: category, source, location, title, and summary;
(D) means for displaying, responsive to the at least one set of search results returned, the at least one set of search results to the user, including a first display means for characterizing the at least one set of search results by category; and a second display means for characterizing a site search summary, including data representative of each source of said plurality of sources searched, an icon representing the category corresponding to each source of said plurality of sources searched, and a number of resources in each source of said plurality of sources searched responsive to the search query;
(E) means for displaying, responsive to a first selection of at least one of the category and the icon for the category in at least one of said first display means and said second display means, the at least one set of search results corresponding to said category;
(F) means for displaying, responsive to a second selection of at least one of said plurality of sources searched, in at least one of said first display means and said second display means, the at least one set of search results in said at least one of said plurality of sources;
(G) means for displaying, responsive to a third selection of one of said plurality of electronic resources in said at least one set of search results, content corresponding to said one of said plurality of electronic resources;
(H) means for checking a registration data for the user to ensure that the user is permitted access to a source that is restricted and that corresponds to one of said responsive plurality of electronic resources, and if the user is not permitted access, means for excluding the source from at least one of the displaying means; and
(I) means for instructing the search engine to update the at least one search index directed to the plurality of sources by categories.

15. A computer-implemented medical resource search system for providing source specific sets of search results and a site search summary to a user including at least one of a physician and a healthcare provider, said search system comprising:
(A) at least one search query, generated in response to a search request received from the user, said at least one search query including at least one search term and a scope of sources to be searched, wherein a plurality of sources correspond to one of a plurality of categories including at least one of medical news, medical library, and medical profession; and wherein a plurality of electronic resources correspond to each of said plurality of sources;
(B) a search, performed in response to the at least one search query, for the at least one search term in the plurality of electronic resources corresponding to the scope of sources;
(C) at least one set of search results, having a first indication of resources responsive to said at least one search query;
(D) a search results display, responsive to the at least one set of search results returned, of the at least one set of search results to the user, including a first display of the at least one set of search results by category; and a second display of a site search summary, including data representative of each source of the plurality of sources searched, and data representing the category corresponding to each source of said plurality of sources searched;
(E) a category results display, responsive to a first selection of the category in at least one of said first display and said second display, of the at least one set of search results corresponding to said category;
(F) a source results display, responsive to a second selection of at least one of said plurality of sources searched, in at least one of said first display and said second display, of the at least one set of search results in said at least one of said plurality of sources; and
(G) a content display, responsive to a third selection of one of said plurality of electronic resources in said at least one set of search results, content corresponding to said one of said plurality of electronic resources.

16. The system of claim 15, further comprising a validation of a registration data for the user to ensure that the user is permitted access to a source that is restricted and that corresponds to one of said responsive plurality of electronic resources, and if the user is not permitted access, to exclude the source from at least one of the displays.

17. The system of claim 15, wherein said search uses at least one search index for the search engine, and further comprising at least one instruction to the search engine to update the at least one search index directed to the plurality of sources by categories.

18. The system of claim 15, wherein said at least one set of search results further has, for each of said plurality of electronic resources, a second indication of at least one of: category, source, location, title and summary.

19. The system of claim 15, wherein said data representing the category in said second display includes an icon representing the category, and the first selection is of at least one of the category and the icon representing the category.

20. The system of claim 15, wherein the plurality of categories include at least one of medical news, medical library, and medical profession.

21. A computer-implemented medical resource search system for providing source specific sets of search results and a site search summary to a user including at least one of a physician and a healthcare provider, said search system comprising:
(A) at least one search query, generated in response to a search request received from the user, the at least search query including at least one search term and a scope of sources to be searched, wherein a plurality of sources correspond to one of a plurality of categories including at least one of medical news, medical library, and medical profession; and wherein a plurality of electronic resources correspond to each of said plurality of sources;
(B) a search, performed in response to the at least one search query, for the at least one search term in the plurality of electronic resources corresponding to the scope of sources, said search using at least one search index for the search engine;
(C) at least one set of search results, having first indication of resources responsive to said at least one search query, and for each of said plurality of electronic resources a second indication of at least one of: category, source, location, title, and summary;
(D) a search results display, responsive to the at least one set of search results returned, of the at least one set of search results to the user, including a first display of the at least one set of search results by category; and a second display of a site search summary, including data representative of each source of said plurality of sources searched, an icon representing the category corresponding to each source of said plurality of sources searched, and a number of resources in each source of said plurality of sources searched responsive to the search query;
(E) a category results display, responsive to a first selection of at least one of the category and the icon for the category in at least one of said first display and said second display, of the at least one set of search results corresponding to said category;
(F) a source results display, responsive to a second selection of at least one of said plurality of sources searched, in at least one of said first display and said second display, of the at least one set of search results in said at least one of said plurality of sources;
(G) a content display, responsive to a third selection of one of said plurality of electronic resources in said at least one set of search results, of content corresponding to said one of said plurality of electronic resources;
(H) a validation of a registration data for the user to ensure that the user is permitted access to a source that is restricted and that corresponds to one of said responsive plurality of electronic resources, and if the user is not permitted access, to exclude the source from at least one of the displays; and
(I) at least one instruction to the search engine to update the at least one search index directed to the plurality of sources by categories.
